(19) United States
(12) Patent Application Publication
(10) Pub. No.: US 2014/0059104 A1
(43) Pub. Date: Feb. 27, 2014

(54) ARITHMETIC CIRCUIT FOR CALCULATING CORRECTION VALUE

(71) Applicant: FUJITSU LIMITED, Kawasaki-shi (JP)

(72) Inventors: Kensuke Shinomiya, Inagi (JP); Kenichi Kitamura, Kawasaki (JP)

(21) Appl. No.: 13/935,610

(22) Filed: Jul. 5, 2013

(30) Foreign Application Priority Data
Aug. 23, 2012 (JP) 2012-184594

(51) Int. Cl. G06F 7/485

(52) U.S. Cl. CPC G06F 7/485
USPC 708/495

(57) ABSTRACT

An arithmetic circuit for calculating a correction value for a result of an arithmetic operation that is an addition or subtraction performed with respect to a first floating-point number and a second floating-point number smaller than the first floating-point number. The arithmetic circuit includes a generation unit configured to generate a significand of a normalized correction value for the result of the arithmetic operation and an exponent of the normalized correction value based on the sign, the significand, and the exponent of the second floating-point number when a difference between a result of subtracting the leading zero count of the significand of the first floating-point number from the corresponding exponent and a result of subtracting a leading zero count of the significand of the second floating-point number from the corresponding exponent is larger than or equal to a second predetermined value.

### CROSS-REFERENCE TO RELATED APPLICATIONS

The present application is based upon and claims the benefit of priority from the prior Japanese Patent Application No. 2012-184594 filed on Aug. 23, 2012, with the Japanese Patent Office, the entire contents of which are incorporated herein by reference.

### FIELD

The disclosures herein relate to an arithmetic circuit, a processor, and a method of controlling a processor.

### BACKGROUND

An accounting system such as a banking system and some type of scientific computation are expected to have small error in numerical expression and computation. To this end, multiple-precision numerical representation having a bit width several times as wide as the bit width of a single-precision numerical representation or variable-precision numerical representation may be employed. In such a case, a single integer may express a sign and an exponent. Further, a digit string separate from the sign and the exponent may often be used to represent a significand. When such numerical representation is employed, integer calculation may often be utilized to implement arithmetic operation between numerical values.

In contrast, study has been underway on a method for implementing multiple-precision or variable-precision floating-point arithmetic by use of fixed-precision floating-point arithmetic (Patent Document 1 and Patent Document 2, for example). It is often the case that hardware provides a high-speed processing means to perform fixed-precision floating-point arithmetic. The use of the method as described above can thus increase processing speed. For example, there is a library that performs multiple-precision binary floating-point arithmetic by use of double-precision floating-point arithmetic (Patent Document 3, for example).

In such a method, a single number is represented by a set of fixed-precision floating-point numbers, which may be referred to as an “unvalued sum” because the set is used as it is, without adding up the individual numbers. Arithmetic operation between different sets may be properly designed to implement a high-precision arithmetic operation.

In the existing studies, various types of arithmetic operations for fixed-precision floating-point arithmetic are designed only with respect to conventional arithmetic operations. In contrast, there is a method that utilizes an added dedicated instruction to perform more efficient processing (Patent Document 1, for example). The relevant algorithm is expressed as follows. In order to provide an accurate sum of two fixed-precision floating-point numbers, the result of arithmetic is provided as two fixed-precision floating-point numbers z and zz.

Two-sum-fast(x,y)

z=fi(x+y)

zz=get_{—}zz(x,y)

return(z,zz)

The arithmetic fi(x+y) is addition performed as fixed-precision floating-point arithmetic. get_zz is a newly added instruction.

The two numbers z and zz obtained by the above-noted Two-sum arithmetic satisfies the following condition: z+zz=x+y. Value z represents the most significant part of x+y within the precision of the fixed-precision floating-point number format. Value zz represents a remainder (i.e., correction value for a added or subtracted value) that is left unexpressed by the precision of the fixed-precision floating-point number format. FIGS. 1A through 1C are drawings illustrating z and zz. FIG. 1A illustrates a first fixed-precision floating-point number, and FIG. 1B illustrates a second fixed-precision floating-point number. FIG. 1C illustrates z and zz that are obtained by adding the significand of the first fixed-precision floating-point number and the significand of the second fixed-precision floating-point number upon aligning their digits.

In order to achieve the above-noted algorithm, overflow or underflow occurring with respect to the result of fi(x+y) may preferably be reflected in the result of the get_zz process (i.e., the process for obtaining a correction value for an added or subtracted value).
[Patent Document 1] Japanese Laid-open Patent Publicataion No. 2012-221189
[Non-Patent Document 1] T. Dekker, A Floating-Point Technique for Extending the Available Precision, Number. Math. vol. 18, pp. 224-242, 1971.
[Non-Patent Document 2] D. Priest, On Property of Floating Point Arithmetics: Numerical Stability and the Cost of Accurate Computations, PhD thesis, University of California, Berkeley, November 1992.
[Non-Patent Document 3] Yozo Hida, Xiaoye S. Li, David H. Bailey, Library for Double-Double and Quad-Double Arithmetic, 29 Dec. 2007.

### SUMMARY

According to an aspect of the embodiment, an arithmetic circuit for calculating a correction value for a result of an arithmetic operation that is an addition or subtraction performed with respect to a first floating-point number and a second floating-point number smaller than the first floating-point number, includes a first input register configured to store a first sign, a first significand, and a first exponent of the first floating-point number, a second input register configured to store a second sign, a second significand, and a second exponent of the second floating-point number, an arithmetic unit configured to produce a shift amount that is a result of subtracting from the first exponent the second exponent and also a leading zero count of the first significand, and to produce a third exponent that is a result of subtracting from the first exponent the leading zero count of the first significand and a first predetermined value, a shift unit configured to generate a shifted significand that is a result of shifting the first significand based on the generated shift amount, an addition unit configured to produce a sum obtained by adding the shifted significand to a portion of the second significand, and to produce carry information indicative of presence or absence of a carry generated together with the sum, a prediction unit configured to generate a flag indicative of overflow or underflow based on the shifted significand, the shift amount, and the carry information, and a generation unit configured to generate a significand of a normalized correction value for the result of the arithmetic operation and an exponent of the normalized correction value based on the second sign, the second significand, and the second exponent when a difference between a result of subtracting the leading zero count of the first significand from the first exponent and a result of subtracting a leading zero count of the second significand from the second exponent is larger than or equal to a second predetermined value, and to generate the significand and exponent of the normalized correction value based on the sum, the third exponent, the shift amount, and the flag when the difference is smaller than the second predetermined value.

According to another aspect, a processor includes an arithmetic circuit for calculating a correction value for a result of an arithmetic operation that is an addition or subtraction performed with respect to a first floating-point number and a second floating-point number smaller than the first floating-point number, and an instruction control unit configured to decode an instruction for calculating the correction value, wherein the arithmetic circuit includes a first input register configured to store a first sign, a first significand, and a first exponent of the first floating-point number, a second input register configured to store a second sign, a second significand, and a second exponent of the second floating-point number, an arithmetic unit configured to produce a shift amount that is a result of subtracting from the first exponent the second exponent and also a leading zero count of the first significand, and to produce a third exponent that is a result of subtracting from the first exponent the leading zero count of the first significand and a first predetermined value, a shift unit configured to generate a shifted significand that is a result of shifting the first significand based on the generated shift amount, an addition unit configured to produce a sum obtained by adding the shifted significand to a portion of the second significand, and to produce carry information indicative of presence or absence of a carry generated together with the sum, a prediction unit configured to generate a flag indicative of overflow or underflow based on the shifted significand, the shift amount, and the carry information, and a generation unit configured to generate a significand of a normalized correction value for the result of the arithmetic operation and an exponent of the normalized correction value based on the second sign, the second significand, and the second exponent when a difference between a result of subtracting the leading zero count of the first significand from the first exponent and a result of subtracting a leading zero count of the second significand from the second exponent is larger than or equal to a second predetermined value, and to generate the significand and exponent of the normalized correction value based on the sum, the third exponent, the shift amount, and the flag when the difference is smaller than the second predetermined value.

According to another aspect, a method is provided to control a processor which includes a first input register configured to store a first sign, a first significand, and a first exponent of the first floating-point number, a second input register configured to store a second sign, a second significand, and a second exponent of the second floating-point number, an arithmetic circuit configured to calculate a correction value for a result of an arithmetic operation that is an addition or subtraction performed with respect to the first floating-point number and the second floating-point number smaller than the first floating-point number, and an instruction control unit configured to decode an instruction for calculating the correction value. The method includes decoding the instruction by use of the instruction control unit, producing, by use of an arithmetic unit of the arithmetic circuit, a shift amount that is a result of subtracting from the first exponent the second exponent and also a leading zero count of the first significand, and to produce a third exponent that is a result of subtracting from the first exponent the leading zero count of the first significand and a first predetermined value, generating, by use of a shift unit of the arithmetic circuit, a shifted significand that is a result of shifting the first significand based on the generated shift amount, producing, by use of an addition unit of the arithmetic circuit, a sum obtained by adding the shifted significand to a portion of the second significand, and to produce carry information indicative of presence or absence of a carry generated together with the sum, generating, by use of a prediction unit of the arithmetic circuit, a flag indicative of overflow or underflow based on the shifted significand, the shift amount, and the carry information, and generating, by use of a generation unit of the arithmetic circuit, a significand of a normalized correction value for the result of the arithmetic operation and an exponent of the normalized correction value based on the second sign, the second significand, and the second exponent when a difference between a result of subtracting the leading zero count of the first significand from the first exponent and a result of subtracting a leading zero count of the second significand from the second exponent is larger than or equal to a second predetermined value, and generating, by use of the generation unit of the arithmetic circuit, the significand and exponent of the normalized correction value based on the sum, the third exponent, the shift amount, and the flag when the difference is smaller than the second predetermined value.

The object and advantages of the embodiment will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIGS. 1A through 1C are drawings illustrating a sum of two floating-point numbers that is expressed within the precision of a floating-point number format and illustrating a residual that is left unexpressed by such precision;

FIG. 2 is a drawing illustrating a table of specific examples of Oracle-numbers;

FIG. 3 is a drawing illustrating a first algorithm that is an example of a get_zz algorithm;

FIG. 4 is a drawing illustrating an example of the configuration of an arithmetic device that performs the first algorithm to process floating-point decimal numbers in the 8-byte-width Oracle-number format;

FIG. 5 is a drawing illustrating an example of the configuration of an exponent-&-significand arithmetic unit of the arithmetic device illustrated in FIG. 4;

FIG. 6 is a drawing illustrating an example of the configuration of a normalization circuit of the arithmetic device illustrated in FIG. 4;

FIG. 7 is a drawing illustrating an example of an algorithm for fi(x+y);

FIG. 8 is a drawing illustrating an example of a get_zz algorithm;

FIG. 9 is a drawing illustrating an example of the configuration of a fi(x+y) arithmetic device that performs a second algorithm to process floating-point decimal numbers in the 8-byte-width Oracle-number format;

FIG. 10 is a drawing illustrating an example of the configuration of a get_zz arithmetic device that performs a second algorithm to process floating-point decimal numbers in the 8-byte-width Oracle-number format;

FIG. 11 is a drawing illustrating an example of the configuration of an exponent-&-significand arithmetic unit of the fi(x+y) arithmetic device illustrated in FIG. 9;

FIG. 12 is a drawing illustrating an example of the configuration of a normalization circuit of the fi(x+y) arithmetic device illustrated in FIG. 9;

FIG. 13 is a drawing illustrating an example of the configuration of the exponent-&-significand arithmetic unit of the get_zz arithmetic device illustrated in FIG. 10;

FIG. 14 is a drawing illustrating an example of the configuration of an overlapping-digit discarding circuit of the get_zz arithmetic device illustrated in FIG. 10;

FIG. 15 is a drawing illustrating an example of the configuration of the normalization circuit of the get_zz arithmetic device illustrated in FIG. 10;

FIG. 16 is a drawing illustrating an example of a get_zz algorithm;

FIGS. 17A and 17B are flowcharts illustrating examples of an overflow prediction process and an underflow prediction process, respectively;

FIGS. 18A through 18E are drawings illustrating examples of a leading zero counting process;

FIGS. 19A and 19B are drawings illustrating examples of fi(x+y) calculation and get_zz calculation in the case of occurrence of overflow in binary representation;

FIGS. 20A and 20B are drawings illustrating examples of fi(x+y) calculation and get_zz calculation in the case of occurrence of one-digit underflow in binary representation;

FIGS. 21A and 21B are drawings illustrating examples of fi(x+y) calculation and get_zz calculation in the case of occurrence of three-digit underflow in binary representation;

FIG. 22 is a drawing illustrating an example of the configuration of a computer system;

FIG. 23 is a drawing illustrating an example of the configuration of a get_zz arithmetic device that processes floating-point decimal numbers in the 8-byte-width Oracle-number format;

FIG. 24 is a drawing illustrating an example of the configuration of an exponent-&-significand arithmetic unit of the get_zz arithmetic device illustrated in FIG. 23;

FIG. 25 is a drawing illustrating an example of the configuration of an OVF&UDF-prediction circuit of the get_zz arithmetic device illustrated in FIG. 23;

FIG. 26 is a drawing illustrating an example of the configuration of an overlapping-digit discarding circuit of the get_zz arithmetic device illustrated in FIG. 23;

FIG. 27 is a drawing illustrating an example of the configuration of a fi(x+y) arithmetic device that processes floating-point decimal numbers in the 8-byte-width Oracle-number format;

FIG. 28 is a drawing illustrating an example of the configuration of an arithmetic device that can perform both the get_zz arithmetic and the fi(x+y) arithmetic;

FIG. 29 is a drawing illustrating an example of the configuration of an exponent-&-significand arithmetic unit of the arithmetic device illustrated in FIG. 28; and

FIG. 30 is a drawing illustrating an example of the configuration of an overlapping-digit discarding circuit of the arithmetic device illustrated in FIG. 28.

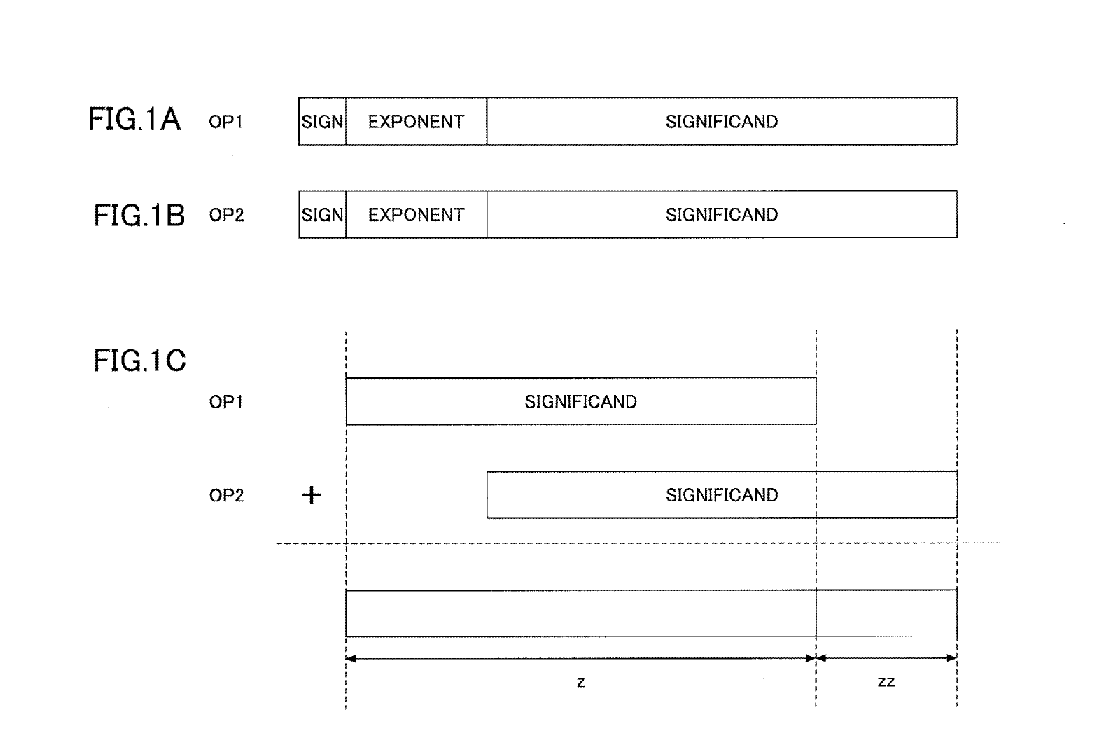

### DESCRIPTION OF EMBODIMENTS

In the following, embodiments of the invention will be described with reference to the accompanying drawings. In each of the drawings, the same or corresponding elements are referred to by the same or corresponding symbols or numbers, and a description thereof will be omitted as appropriate.

The descriptions given below use, as an example of numerical-number expression, a floating-point decimal number in the form of Oracle-numbers (registered trademark) which are the numerical number type used in the Oracle database (registered trademark). An Oracle-number is represented in a variable-precision data format including up to a maximum of 21 bytes. The first byte stores a sign and an exponent, and the following bytes store a significand. The significand extends up to a maximum of 20 bytes.

The Oracle-number format is a data format for representing a floating-point decimal number. Mainly because of the efficiency of memory utilization, the significand has two digits of a decimal number in each byte. Matching this notation, the exponent stores an exponent number in respect of a radix of 100. A number represented by the Oracle-number format can be expressed as follows.

number=±(M00. M01 MO2 . . . )*100̂(exp) Here, M00, M01, M02, and so on represent the data of respective bytes, i.e., the first byte, the second byte, the third byte, and so on, of the significand extending up to a maximum of 20 bytes. Since the significand is sectioned in units of two digits of a decimal number, the significand can be regarded as having 20 digits of a centesimal number. An Oracle-number is normalized without exception when viewed as a centesimal number. Under no circumstances, does the M00 part (i.e., the first byte of the significand) become zero.

The first byte of the Oracle-number format (i.e., the first byte of the entire number) contains a sign and an exponent, which are encoded as follows.

In the case of number>0: First Byte=exp+193

In the case of number==0: First Byte=128

Otherwise: First Byte=62−exp

The significand in the second byte and onwards contain M00, M01, and so on in the respective bytes thereof. In each byte, different encoding methods are used as illustrated below, depending on the sign of the expressed numerical number.

In the case of number>0: Significand's n-th Byte=M(n−1)+1

In the case of number==0: No Significand

Otherwise: Significand's n-th Byte=101−M(n−1)

With these encoding methods, 0x00 never appear in any byte of the significand since Mn ranges from 0 to 99. When the number to be expressed can be expressed by a short significand, this Oracle-number becomes shorter than 21 bytes. Namely, trailing zeros are not permitted in the significand of an Oracle-number. In the case of a negative number, a terminator of 102 (0x66) is stored in the last byte in order to indicate the tail end of the significand when the significand is shorter than 20 bytes.

The use of the encoding scheme described above in the Oracle-number format ensures that the magnitude relationship as viewed as byte strings, i.e., the magnitude relationship based on comparison utilizing the C-language standard function memcmp, be the same as the magnitude relationship between values expressed in the Oracle-number format.

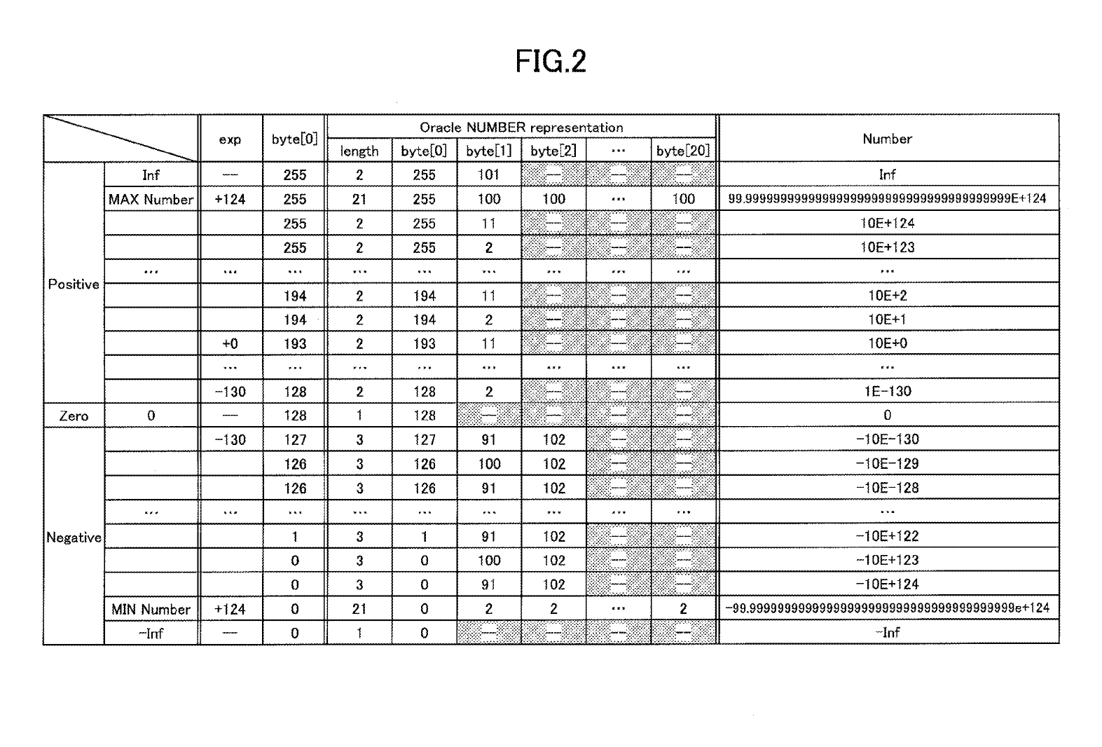

FIG. 2 is a drawing illustrating a table of specific examples of Oracle-numbers. In the expression of 10E+0 (=10×100⁰), for example, the exponent is 193 (=0+193), and the significand is 11 (=10+1). In the expression of 10E+1 (=10×100¹), for example, the exponent is 194 (=1+193), and the significand is 2 (=1+1). In the expression of a negative number of −10E−130 (=−10×100⁻⁶⁵), for example, the exponent is 127 (=62−(−65)), and the significand is 91 (=101−10). In the expression of a negative number of −10E−129 (=−10×100⁻⁶⁴), for example, the exponent is 126 (=62−(−64)), and the significand is 100 (=101−1). For the negative numbers, the terminator “102” is attached as the last byte. Further, the positive infinite number Inf and the negative infinite number −Inf are assigned to special byte strings as illustrated in the table.

As a method of implementing the get_zz instruction, a double-precision intermediate value and a double-precision addition process may be utilized.

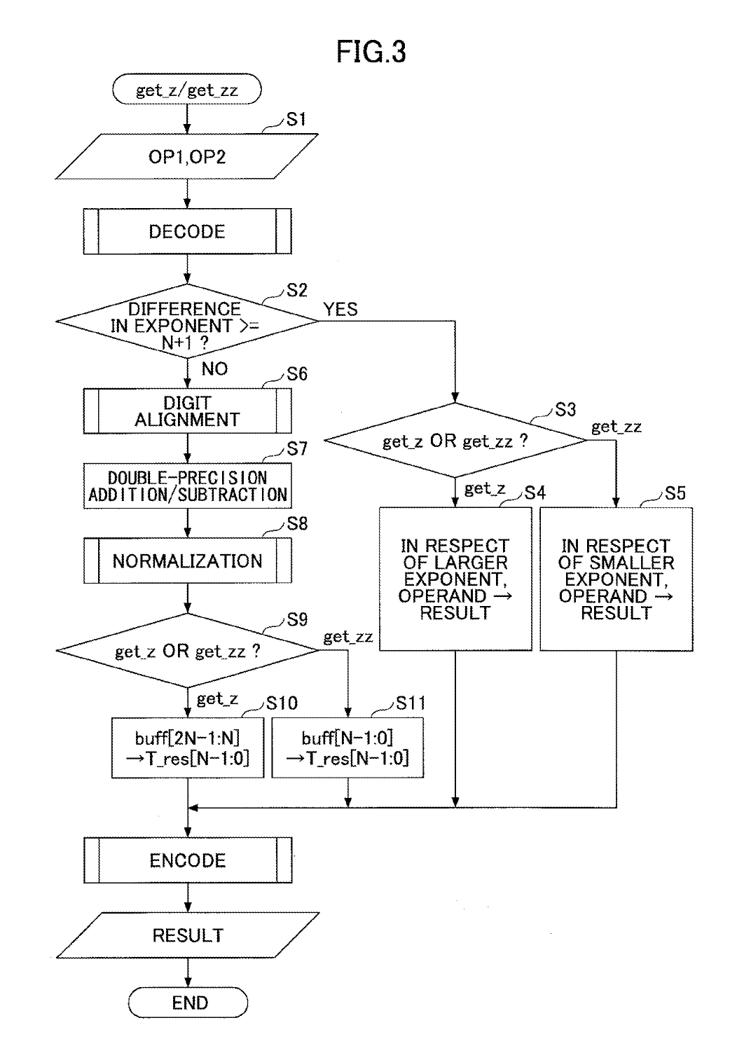

FIG. 3 is a drawing illustrating a first algorithm as an example of the get_zz algorithm. The procedure is as follows.

Data OP1 and OP2 represented in a floating-point number format are provided as inputs (step S1). The data format of the input data is not limited to any specific format, and the data do not have to be normalized. When a difference in exponents between OP1 and OP2 after normalization is N+1 or more (N: a maximum number of input digits) (YES in step S2), a special process to provide an input to a normalization circuit through a bypass is performed. In so doing, a set of an exponent, a significand, and a sign of a selected one of the two inputs is supplied through a bypass to the normalization circuit such that the selected one is the input having a greater exponent in the case of the fi(x+y) process, and is the input having a smaller exponent in the case of the get_zz process (step S3 through S5).

When a difference in exponents between OP1 and OP2 after normalization is smaller than N+1 (NO in step S2), a digit alignment process is performed as a normal case. A difference in exponents between OP1 and OP2 is obtained, based on which shifting is performed to align the digits (step S6). Addition or subtraction is performed (step S7). In so doing, an addition operation uses a width of 2N digits in order to cover valid digits of the input values. Normalization is performed (step S8). In the case that the special process to use the bypass has been performed, the bypass input is used. The N upper-order digits of the result in the case of the fi(x+y) process and the N lower-order digits of the result in the case of the get_zz process are selected and output (steps S9 through S11).

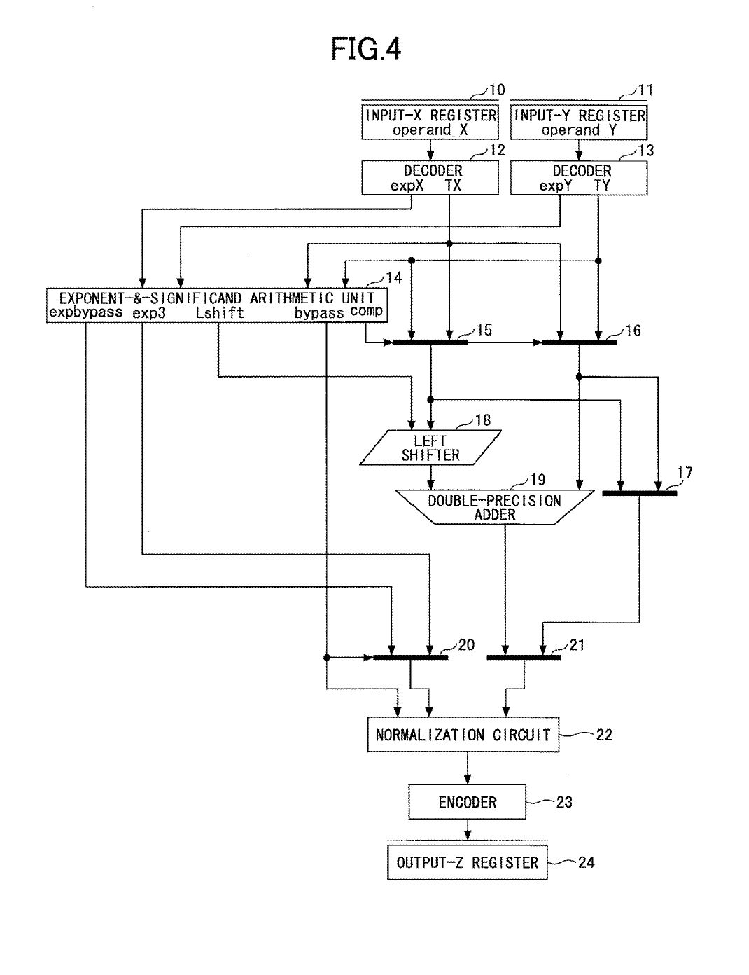

FIG. 4 is a drawing illustrating an example of the configuration of an arithmetic device that performs the first algorithm to process floating-point decimal numbers in the 8-byte-width Oracle-number format. The arithmetic device illustrated in FIG. 4 includes an input-X register 10, an input-Y register 11, decoders 12 and 13, an exponent-&-significand arithmetic unit 14, selectors 15 through 17, a left shifter 18, a double-precision adder 19, selectors 20 and 21, a normalization circuit 22, an encoder 23, and an output-Z register 24.

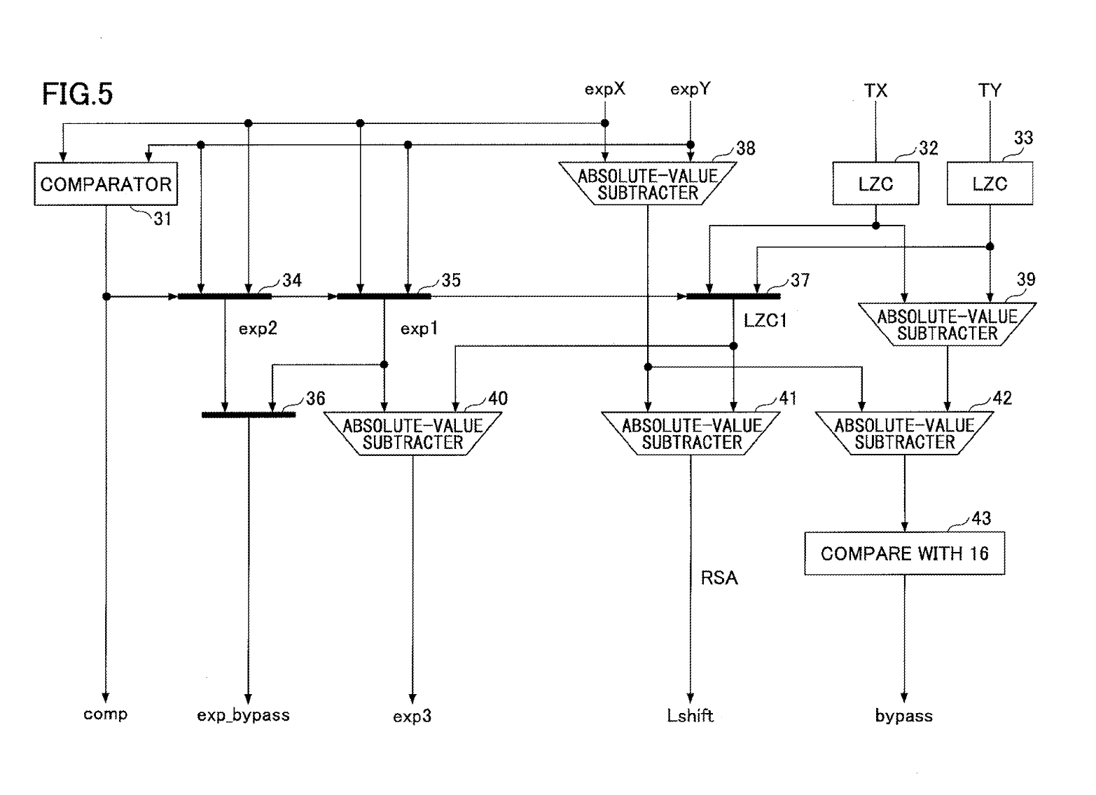

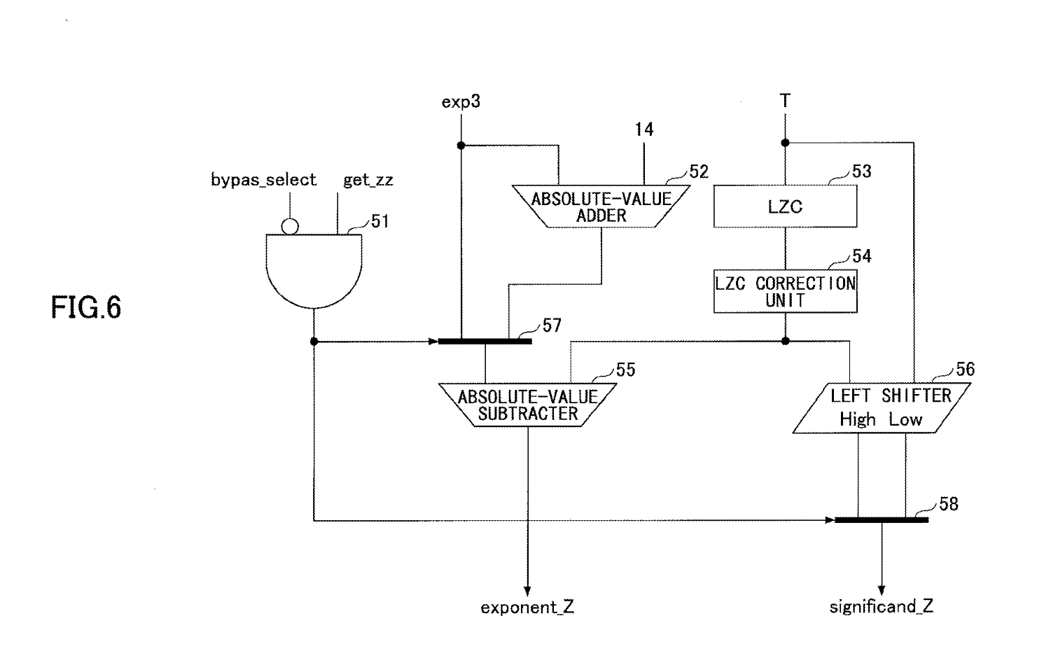

FIG. 5 is a drawing illustrating an example of the configuration of the exponent-&-significand arithmetic unit 14 of the arithmetic device illustrated in FIG. 4. The exponent-&-significand arithmetic unit 14 includes a comparator 31, LZC counters 32 and 33, selectors 34 through 37, absolute-value subtracters 38 through 42, and a comparator 43. FIG. 6 is a drawing illustrating an example of the configuration of the normalization circuit 22 of the arithmetic device illustrated in FIG. 4. The normalization circuit 22 includes an AND gate 51, an absolute-value adder 52, an LZC counter 53, an LZC correction unit 54, an absolute-value subtracter 55, a left shifter 56, and selectors 57 and 58.

In the following, the operation of the arithmetic device illustrated in FIG. 4 through FIG. 6 will be described. Although floating-point decimal numbers in the 8-byte-width Oracle-number format are used as an example in the descriptions, the decode circuit and the encode circuit may be redesigned such that the disclosed configuration may be usable for both the Oracle-number format and another format.

The inputs and the output are floating-point numbers having the same precision. The input data may or may not be normalized, and the output data is normalized without exception. In the Oracle-number format, the exponent is always an even number. The previously noted algorithm is modified accordingly. For example, provision is made such that a leading zero count obtained by the exponent-&-significand arithmetic unit 14 always becomes an even number. In FIG. 4 and the subsequent figures, an exponent “exp”, a significand T, a leading zero count LZC, a left-shift amount Lshift, a right-shift amount Rshift, an exponent comparison signal “comp”, a bypass select signal “bypass”, an overflow OVF, and an underflow UDF will be used as notation for signals and data.

Data are supplied to the decoder 12 and the decoder 13 from the input-X register 10 and the input-Y register 11, respectively. Each of the decoders 12 and divides an input into a sign, an exponent, and a significand, thereby converting the input into an internal format. The sign, exponent, and significand of the input X and the input Y are referred to as a sign-X, an exponent-X (expX), and a significand-X (TX), and a sign-Y, an exponent-Y (expY), and a significand-Y (TY), respectively.

The exponent-&-significand arithmetic unit 14 receives the exponent-X, the significand-X, the exponent-Y, and the significand-Y. The comparator 31 of the exponent-&-significand arithmetic unit 14 compares the exponent-X and the exponent-Y in terms of their magnitudes, and generates a select signal such that the significand associated with the larger exponent, which will be denoted as exp1, serves as a significand T1, and that the significand associated with the smaller exponent, which will be denoted as exp2, serves as a significand T2.

The absolute-value adder 42 and the comparator 43 of the exponent-&-significand arithmetic unit 14 perform an arithmetic for providing a bypass from an input to the normalization circuit 22 when the absolute value of {(exponent-X−the count indicative of the number of leading zeros in significand-X)−(exponent-Y−the count indicative of the number of leading zeros in significand-Y)} is larger than or equal to 16. The exponent-&-significand arithmetic unit 14 generates a select signal such that the significand T2 and the sign and exponent associated therewith are bypassed, and also outputs an exponent to be bypassed.

The absolute-value subtracter 41 of the exponent-&-significand arithmetic unit 14 outputs (exponent exp1−exponent exp2−the count indicative of the number of leading zeros in significand T1) as a shift amount RSA to be supplied to the left shifter 18. When the leading zero count of the significand T1 is an odd number, this number is decreased by 1.

The absolute-value subtracter 40 of the exponent-&-significand arithmetic unit 14 calculates an exponent exp3 that is the result of subtracting the leading zero count of the significand T1 from the exponent exp 1, and supplies the exponent exp3 to the normalization circuit 22.

The left shifter 18 shifts the supplied significand to the left according to the supplied shift amount RSA. The significand T1 shifted to the left and the significand T2 without being shifted are supplied to the double-precision adder 19 having a width of 2N. In the case of subtraction, the significand of a subtrahend is inverted to generate one's complement, which is supplied as an input, with “1” being supplied as a carry bit to the double-precision adder 19. The double-precision adder 19 adds up the inputs, and supplies the result to the normalization circuit 22.

In the case of the bypass select signal to the normalization circuit 22 being 1, the bypassed significand and exponent are supplied to the normalization circuit 22. In the case of the bypass select signal to the normalization circuit 22 being 0, the result of addition and the exponent exp3 are supplied to the normalization circuit 22 as a significand and an exponent, respectively.

The AND gate 51, the absolute-value adder 52, the selector 57, and the absolute-value subtracter 55 of the normalization circuit 22 cooperate with each other to subtract the leading zero count of the significand from the exponent, and provides the result of the subtraction as an exponent-Z in the case of the fi(x+y) process or in the case of the bypass select signal being 1. When the bypass select signal is zero in the case of the get_zz process, 14 is further subtracted from the above-noted result, and the resulting value is provided as the exponent-Z.

The left shifter 56 of the normalization circuit 22 shifts the significand to the left by the number of digits equal to the leading zero count of the significand. The 14 upper-order digits of the left-shifted value are used as a significand-Z in the case of the bypass being used or in the case of the fi(x+y) process. In the case of the get_zz process, the 14 lower-order digits of the left-shifted value are used as the significand-Z.

The encoder 23 converts the sign, the exponent-Z, and the significand-Z into an external format for provision to the output-Z register 24.

The first algorithm has been described above. A second algorithm for implementing the get_zz instruction may be designed to control the get_zz instruction based on information about overflow and underflow occurring in the fi(x+y) process.

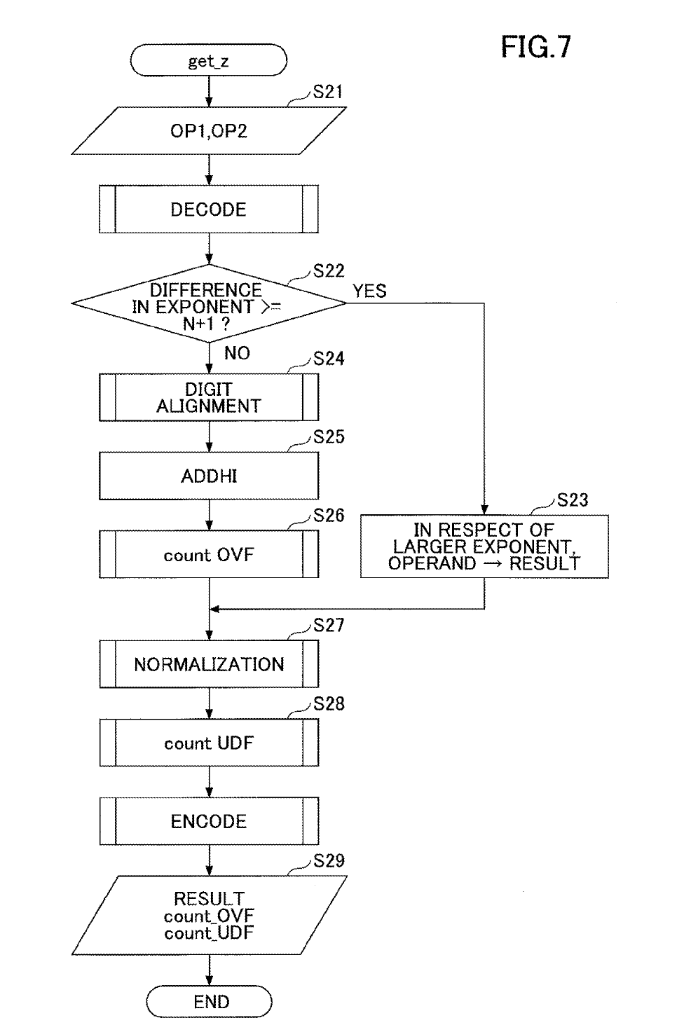

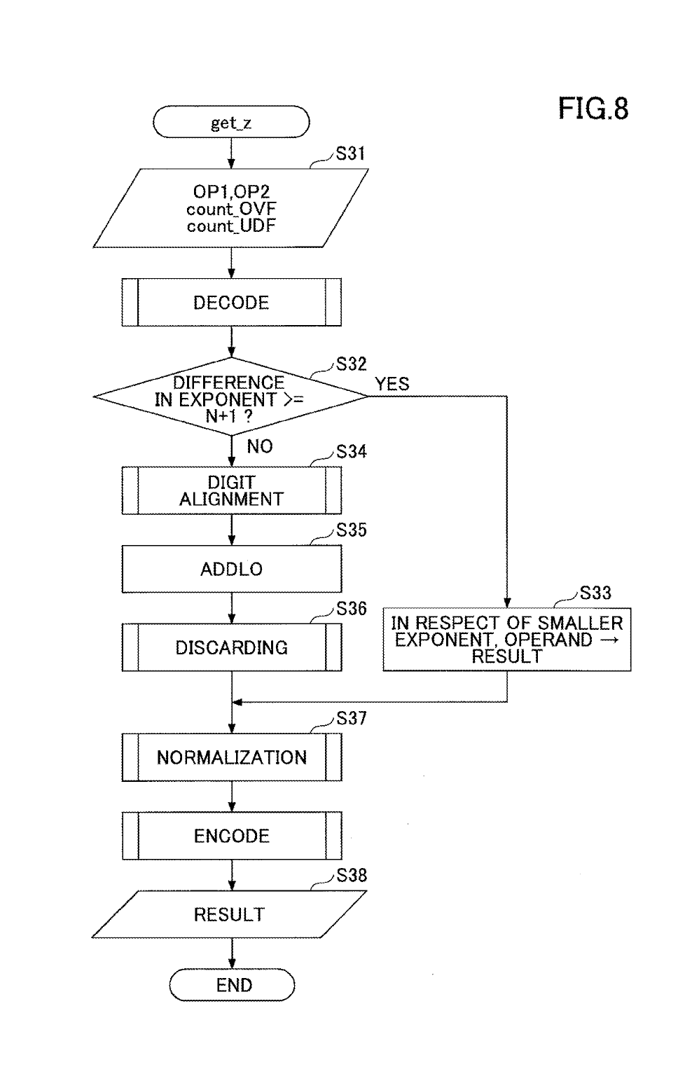

FIG. 7 is a drawing illustrating an example of the algorithm for fi(x+y). FIG. 8 is a drawing illustrating an example of the algorithm for get_zz. The procedures are as follows.

In the fi(x+y) process, data OP1 and OP2 represented in a floating-point number format are provided as inputs (step S21). The data format of the input data is not limited to any specific format, and the data do not have to be normalized. When a difference in exponents between OP1 and OP2 after normalization is N+1 or more (YES in step S22), a special process to provide an input to the normalization circuit through a bypass is performed. In so doing, one of the two inputs having a greater exponent is supplied to the result through the bypass (step S23).

When a difference in exponents between OP1 and OP2 after normalization is smaller than N+1 (NO in step S22), a digit alignment process is performed as a normal case (step S24). Namely, a difference in exponents between OP1 and OP2 is obtained, based on which shifting is performed to align the digits. Addition or subtraction is performed with respect to the N upper-order digits of the inputs (step S25). An overflow amount is obtained based on the result of addition (step S26).

Normalization is performed (step S27). In the case that the special process to use the bypass has been performed, the bypass input is used. The leading zero count at the time of the normalization process is output as an underflow amount (step S28). The result of addition, the overflow digit count, and the underflow digit count are output (step S29).

In the get_zz process, data OP1 and OP2 represented in a floating-point number format are provided as inputs (step S31). The data format of the input data is not limited to any specific format, and the data do not have to be normalized. When a difference in exponents between OP1 and OP2 after normalization is N+1 or more (YES in step S32), a special process to provide an input to the normalization circuit through a bypass is performed. In so doing, one of the two inputs having a smaller exponent is supplied to the result through the bypass (step S33).

When a difference in exponents between OP1 and OP2 after normalization is smaller than N+1 (NO in step S32), a digit alignment process is performed as a normal case (step S34). Namely, a difference in exponents between OP1 and OP2 is obtained, based on which shifting is performed to align the digits. Addition or subtraction is performed with respect to the N lower-order digits of the inputs (step S35). A process to discard the digits that overlap between the result of upper-order addition and the result of lower-order addition is performed (step S36). In so doing, the shift amount for discarding digits is set equal to “N—the shift amount for digit alignment”. In the case of overflow occurring in the fi(x+y) process, the amount of overflow is subtracted from the shift amount for discarding digits in order to save the overflowing digit. In the case of underflow occurring in the fi(x+y) process, the amount of underflow is added to the shift amount for discarding digits in order to discard the digits that are incorporated into the result of fi(x+y). The significand is shifted to the left by the discarding shift amount (i.e., shift amount for discarding digits). In the case of overflow occurring in the fi(x+y) process, the amount of overflow is added to the supplied exponent. In the case of underflow occurring in the fi(x+y) process, the amount of underflow is subtracted from the supplied exponent.

Normalization is performed (step S37). In the case that the input bypassing special process has been performed, the bypassed exponent and significand are normalized. In the case of no such bypassing special process having been performed, the exponent and significand obtained by the discarding process are normalized. The result of addition is output (step S38).

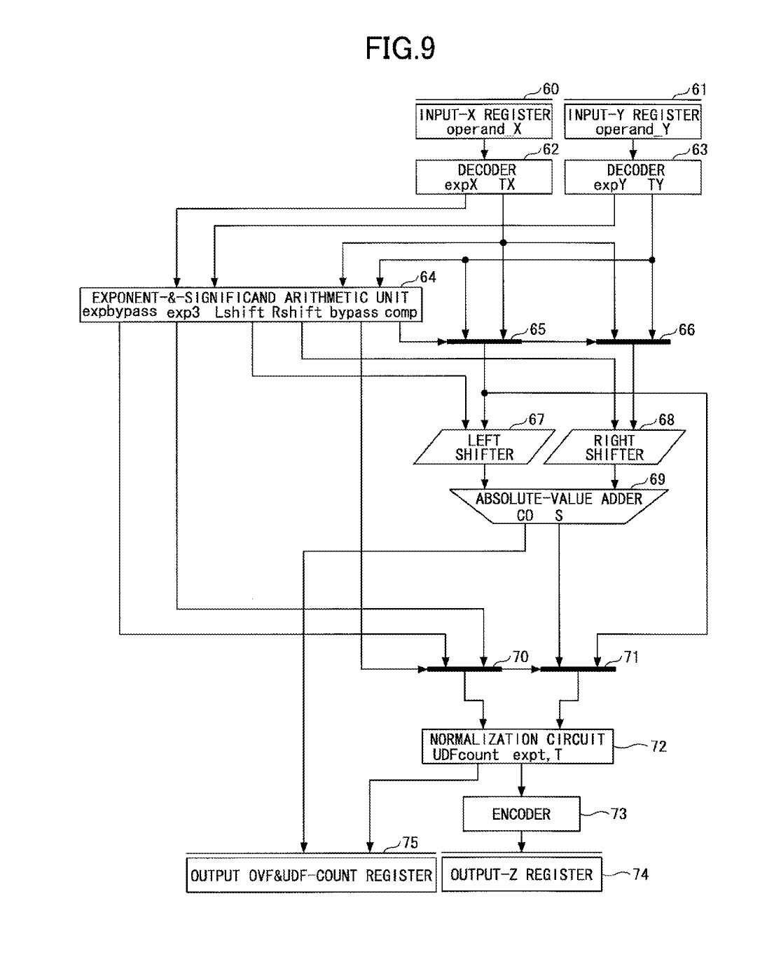

FIG. 9 is a drawing illustrating an example of the configuration of a fi(x+y) arithmetic device that performs the second algorithm to process floating-point decimal numbers in the 8-byte-width Oracle-number format. The fi(x+y) arithmetic device illustrated in FIG. 9 includes an input-X register 60, an input-Y register 61, decoders 62 and 63, an exponent-&-significand arithmetic unit 64, selectors 65 and 66, a left shifter 67, a right shifter 68, an absolute-value adder 69, selectors 70 and 71, and a normalization circuit 72. The fi(x+y) arithmetic device further includes an encoder 73, an output-Z register 74, an output OVF&UDF-count register 75.

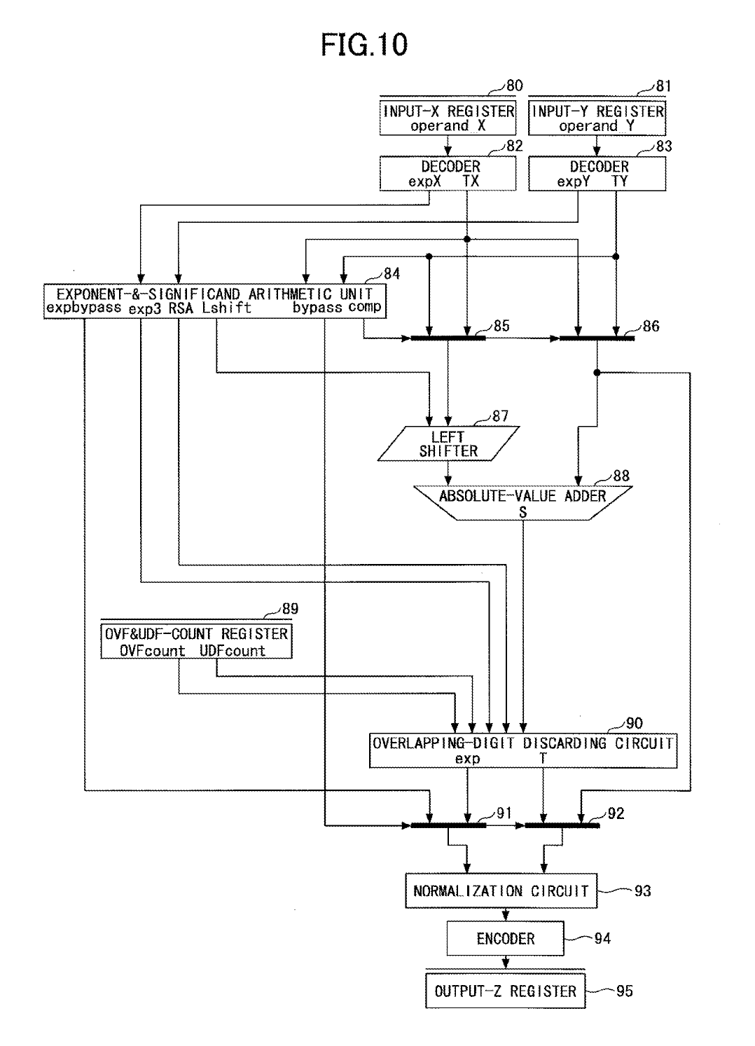

FIG. 10 is a drawing illustrating an example of the configuration of a get_zz arithmetic device that performs the second algorithm to process floating-point decimal numbers in the 8-byte-width Oracle-number format. The get_zz arithmetic device illustrated in FIG. 10 includes an input-X register 80, an input-Y register 81, decoders 82 and 83, an exponent-&-significand arithmetic unit 84, selectors 85 and 86, a left shifter 87, an absolute-value adder 88, an OVF&UDF-count register 89, and an overlapping-digit discarding circuit 90. The get_zz arithmetic device further includes selectors 91 and 92, a normalization circuit 93, an encoder 94, and an output-Z register 95.

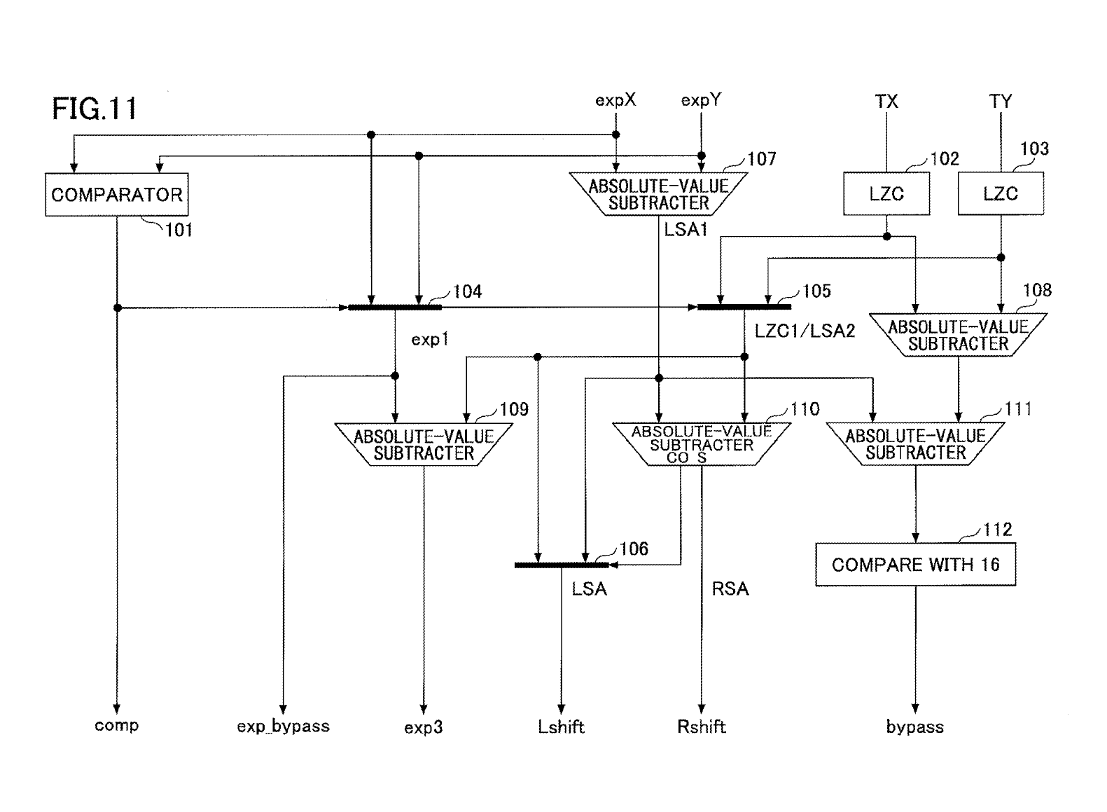

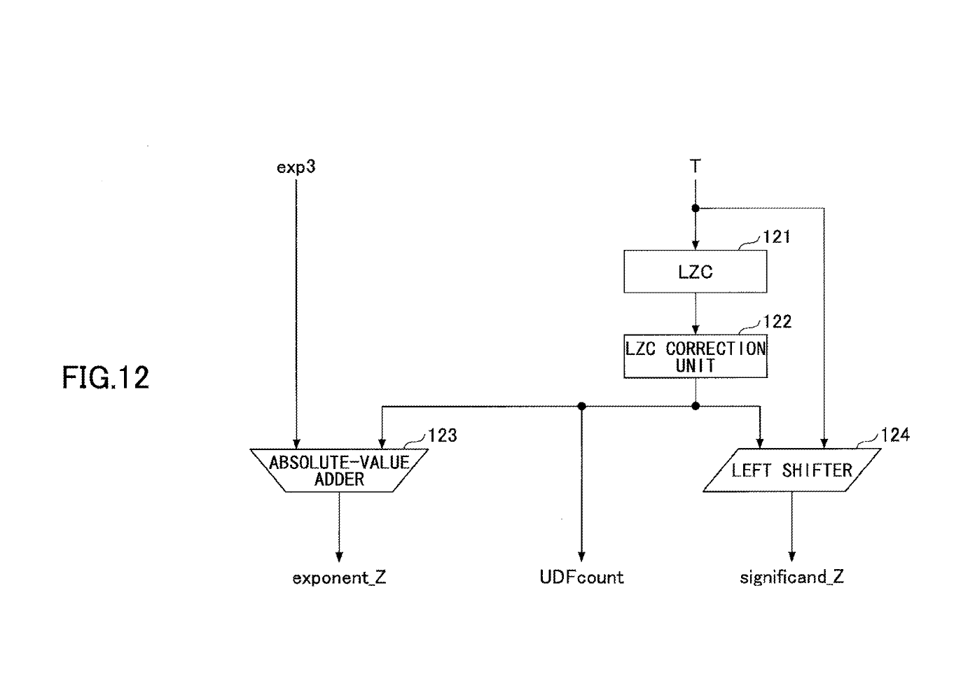

FIG. 11 is a drawing illustrating an example of the configuration of the exponent-&-significand arithmetic unit 64 of the fi(x+y) arithmetic device illustrated in FIG. 9. The exponent-&-significand arithmetic unit 64 includes a comparator 101, LZC counters 102 and 103, selectors 104 through 106, absolute-value subtracters 107 through 111, and a comparator 112. FIG. 12 is a drawing illustrating an example of the configuration of the normalization circuit 72 of the fi(x+y) arithmetic device illustrated in FIG. 9. The normalization circuit 72 includes an LZC counter 121, an LZC correction unit 122, an absolute-value subtracter 123, and a left shifter 124.

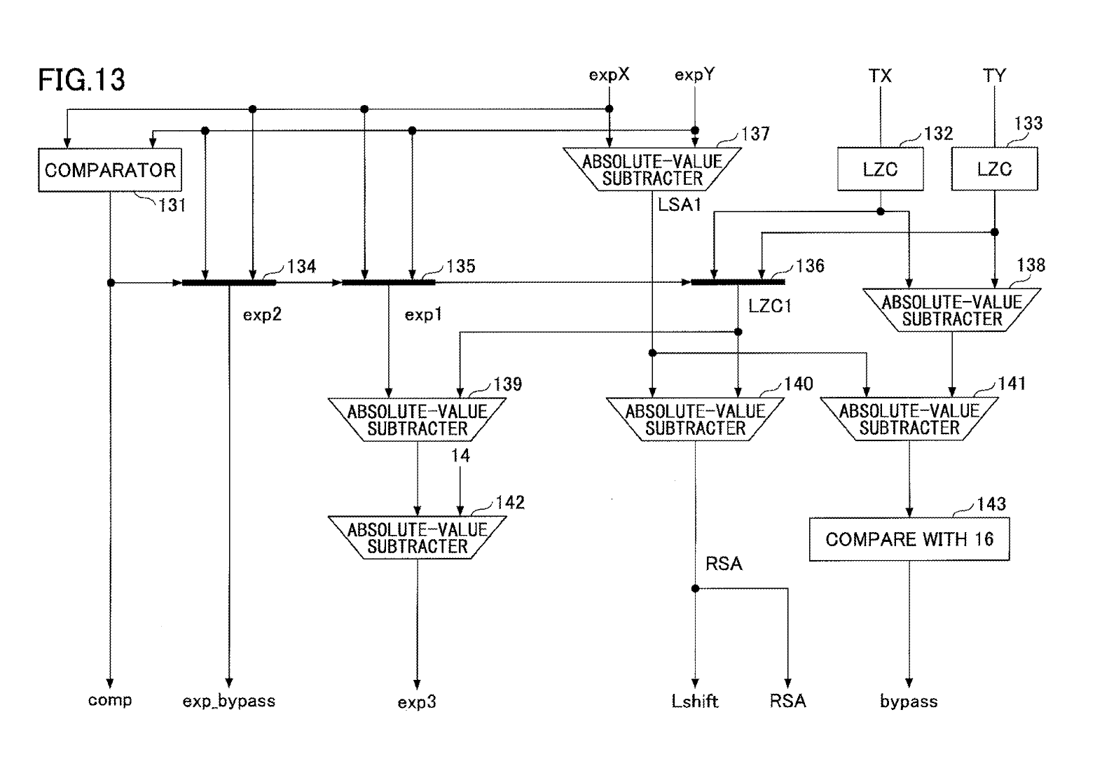

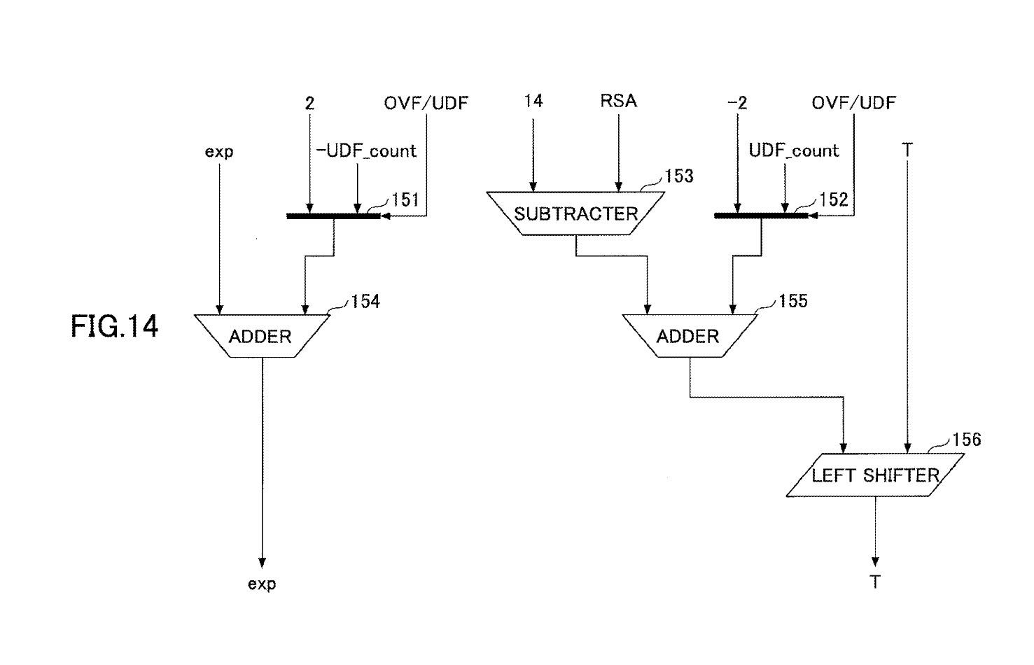

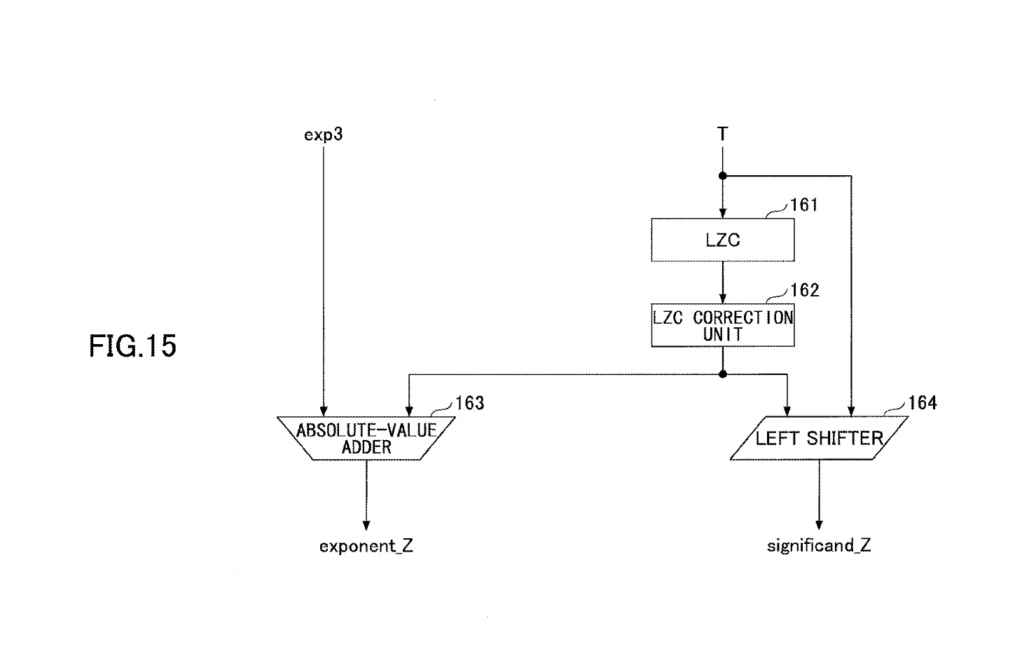

FIG. 13 is a drawing illustrating an example of the configuration of the exponent-&-significand arithmetic unit 84 of the get_zz arithmetic device illustrated in FIG. 10. The exponent-&-significand arithmetic unit 84 includes a comparator 131, LZC counters 132 and 133, selectors 134 through 136, absolute-value subtracters 137 through 142, and a comparator 143. FIG. 14 is a drawing illustrating an example of the configuration of the overlapping-digit discarding circuit 90 of the get_zz arithmetic device illustrated in FIG. 10. The normalization circuit 90 includes selectors 151 and 152, a subtracter 153, adders 154 and 155, and a left shifter 156. FIG. 15 is a drawing illustrating an example of the configuration of the normalization circuit 93 of the get_zz arithmetic device illustrated in FIG. 10. The normalization circuit 93 includes an LZC counter 161, an LZC correction unit 162, an absolute-value subtracter 163, and a left shifter 164.

In the following, the operation of the fi(x+y) arithmetic device illustrated in FIG. 9, FIG. 11, and FIG. 12 will be described.

Data are supplied to the decoder 62 and the decoder 63 from the input-X register 60 and the input-Y register 61, respectively. Each of the decoders 62 and 63 divides an input into a sign, an exponent, and a significand, thereby converting the input into an internal format. The sign, exponent, and significand of the inputs X and Y are referred to as a sign-X, an exponent-X (expX), and a significand-X (TX), and a sign-Y, an exponent-Y (expY), and a significand-Y (TY), respectively.

The exponent-&-significand arithmetic unit 64 receives the exponent-X, the significand-X, the exponent-Y, and the significand-Y. The comparator 101 of the exponent-&-significand arithmetic unit 64 compares the exponent-X and the exponent-Y in terms of their magnitudes, and generates a select signal such that the significand associated with the larger exponent, which will be denoted as exp1, serves as a significand T1, and that the significand associated with the smaller exponent, which will be denoted as exp2, serves as a significand T2.

The absolute-value subtracter 111 and the comparator 112 of the exponent-&-significand arithmetic unit 64 perform an arithmetic for providing a bypass from an input to the normalization circuit 72 when the absolute value of {(exponent-X−the count indicative of the number of leading zeros in significand-X)−(exponent-Y−the count indicative of the number of leading zeros in significand-Y)} is larger than or equal to 16. The exponent-&-significand arithmetic unit 64 generates a select signal such that the significand T1 and the sign and exponent associated therewith are bypassed, and also selects an exponent.

The absolute-value subtracter 107 of the exponent-&-significand arithmetic unit 64 sets a shift amount LSA1 equal to a value of (exp1−exp2). The selector 105 sets a shift amount LSA2 equal to the leading zero count of the significand T1 (i.e., the number of leading zeros in the significand T1). In the case of the count being an odd number, however, the count is decreased by one. The absolute-value subtracter 110 calculates (exponent exp1−exponent exp2−the count indicative of the number of leading zeros in significand T1), and outputs the calculated value as a shift amount RSA. When the leading zero count of the significand T1 is an odd number, this number is decreased by 1. The absolute-value subtracter 110 compares LSA1 with LSA2 to detect which one is larger. In response to the result of comparison, the selector 106 selects LSA2 in the case of LSA1 being smaller, and selects LSA1 in the case of LSA1 being larger, followed by outputting the selected one as LSA. The absolute-value subtracter 109 of the exponent-&-significand arithmetic unit 64 calculates an exponent exp3 that is the result of subtracting the leading zero count of the significand T1 from the exponent exp 1, and supplies the exponent exp3 to the normalization circuit 72.

The exponent-&-significand arithmetic unit 64 supplies the shift amount RSA to the right shifter 68 and the shift amount LSA to the left shifter 67. The left shifter 67 shifts the supplied significand to the left according to the supplied shift amount. The right shifter 68 shifts the supplied significand to the right according to the supplied shift amount. The significand T1 shifted to the left and the significand T2 shifted to the right are supplied to the absolute-value adder 69. In the case of subtraction, the significand of a subtrahend is inverted to generate one's complement, which is supplied as an input, with “1” being supplied as a carry bit to the absolute-value adder 69. The absolute-value adder 69 adds up the inputs, and outputs the result. The carry-out bit of the absolute-value adder 69 is supplied to the output OVF&UDF-count register 75.

In the case of the bypass select signal to the normalization circuit 72 being 1, the bypassed significand and exponent are supplied to the normalization circuit 72. In the case of the bypass select signal to the normalization circuit 72 being 0, the result of addition and the exponent exp3 are supplied to the normalization circuit 72 as a significand and an exponent, respectively.

The absolute-value subtracter 123 of the normalization circuit 72 subtracts the leading zero count of the significand from the exponent, and sets the result to the exponent-Z. The left shifter 124 of the normalization circuit 72 shifts the result of addition to the left by the amount equal to the leading zero count of the significand, and sets the result to the exponent-Z.

In the exponent-&-significand arithmetic unit 64, the leading zero count is output from the normalization circuit 72 to the output OVF&UDF-count register 75. The encoder 73 converts the sign, the exponent-Z, and the significand-Z into an external format for provision to the output-Z register 74.

In the following, the operation of the get_zz arithmetic device illustrated in FIG. 10, FIG. 13, FIG. 14, and FIG. 15 will be described.

Data are supplied to the decoder 82 and the decoder 83 from the input-X register 80 and the input-Y register 81, respectively. The OVF&UDF-count register (which may be the same register as the output OVF&UDF-count register 75 illustrated in FIG. 9) supplies data to the overlapping-digit discarding circuit 90.

Each of the decoders 82 and 83 divides an input into a sign, an exponent, and a significand, thereby converting the input into an internal format. The sign, exponent, and significand of the inputs X and Y are referred to as a sign-X, an exponent-X (expX), and a significand-X (TX), and a sign-Y, an exponent-Y (expY), and a significand-Y (TY), respectively.

The exponent-&-significand arithmetic unit 84 receives the exponent-X, the significand-X, the exponent-Y, and the significand-Y. The comparator 131 of the exponent-&-significand arithmetic unit 84 compares the exponent-X and the exponent-Y in terms of their magnitudes, and generates a select signal such that the significand associated with the larger exponent, which will be denoted as exp1, serves as a significand T1, and that the significand associated with the smaller exponent, which will be denoted as exp2, serves as a significand T2.

The absolute-value subtracter 141 and the comparator 143 of the exponent-&-significand arithmetic unit 84 perform an arithmetic for providing a bypass from an input to the normalization circuit 93 when the absolute value of {(exponent-X−the count indicative of the number of leading zeros in significand-X)−(exponent-Y−the count indicative of the number of leading zeros in significand-Y)} is larger than or equal to 16. The exponent-&-significand arithmetic unit 84 generates a select signal such that the significand T2 and the sign and exponent associated therewith are bypassed, and also outputs an exponent to be bypassed.

The absolute-value subtracter 140 of the exponent-&-significand arithmetic unit 84 calculates (exponent exp1−exponent exp2−the count indicative of the number of leading zeros in significand T1), and outputs the calculated value as a shift amount RSA. When the leading zero count of the significand T1 is an odd number, this number is decreased by 1. The absolute-value subtracter 139 of the exponent-&-significand arithmetic unit 84 subtracts the leading zero count of the significand T1 from the exponent exp 1, and the absolute-value subtracter 142 calculates an exponent exp3 that is the result of subtracting 14 from the output of the absolute-value subtracter 139. The exponent exp3 is then supplied to the overlapping-digit discarding circuit 90.

The exponent-&-significand arithmetic unit 84 supplies the shift amount RSA to the left shifter 87 and the overlapping-digit discarding circuit 90. The left shifter 87 shifts the supplied significand to the left according to the supplied shift amount. The significand T1 shifted to the left and the 14 lower-order digits (i.e., 56 bits) of the significand T2 without being shifted are supplied to the absolute-value adder 88. In the case of subtraction, the significand of a subtrahend is inverted to generate one's complement, which is supplied as an input, with “1” being supplied as a carry bit to the absolute-value adder 88. The absolute-value adder 88 adds up the inputs, and outputs the result.

The overlapping-digit discarding circuit 90 receives the result of addition from the absolute-value adder 88, the exponent exp3 and the shift amount RSA from the exponent-&-significand arithmetic unit 84, as well as the overflow amount and the underflow amount from the OVF&UDF-count register 89. The subtracter 153 of the overlapping-digit discarding circuit 90 sets the shift amount for discarding digits equal to “N−the shift amount for digit alignment”. When the overflow amount is 1 (it can only be either 0 or 1), the subtracter 155 of the overlapping-digit discarding circuit 90 decreases the discarding shift amount by two. When the underflow amount is 0 or more, the subtracter 155 of the overlapping-digit discarding circuit 90 decreases the discarding shift amount by the underflow amount. When the overflow amount is 1, the subtracter 154 of the overlapping-digit discarding circuit 90 adds two to the exponent exp3. When the underflow amount is 0 or more, the subtracter 154 of the overlapping-digit discarding circuit 90 subtracts the underflow amount from the exponent exp3. The left shifter 156 of the overlapping-digit discarding circuit 90 shifts the significand to the left by the discarding shift amount. The overlapping-digit discarding circuit 90 supplies the resulting exponent and significand to the normalization circuit 93.

In the case of the bypass select signal to the normalization circuit 93 being 1, the bypassed significand and exponent are supplied to the normalization circuit 93. In the case of the bypass select signal to the normalization circuit 93 being 0, the significand and exponent output from the overlapping-digit discarding circuit 90 are supplied to the normalization circuit 93.

The LZC counter 161 of the normalization circuit 93 counts the number of leading zeros in the significand. When the leading zero count is an odd number, the LZC correction unit 162 decreases the leading zero count by one. The absolute-value subtracter 163 of the normalization circuit 93 subtracts the leading zero count of the significand from the exponent, and sets the result to the exponent-Z. The left shifter 164 of the normalization circuit 93 shifts the significand to the left by the amount equal to the leading zero count of the significand, and sets the result to the exponent-Z.

The encoder 94 converts the sign, the exponent-Z, and the significand-Z into an external format for provision to the output-Z register 95.

In the case of the first algorithm previously described, the use of double-precision intermediate values and a double-precision addition operation relative to the precision of input data gives rise to a problem in terms of performance and the use of resources. Software implementation involves the use of double-precision type, which increases load on the memory devices. Hardware implementation involves the use of area size that is twice as large. In either case, processing such as addition becomes critical in delay due to the use of double-precision bit width.

In the case of the second algorithm in which information about the overflow and underflow of fi(x+y) is propagated for the purpose of performing the get_zz process, the use of an adder having a normal bit width means that resource constraint is small. However, the expected order of processes are such that the fi(x+y) process is first performed before the get_zz process is performed, thereby posing a constraint on the order of executions of instructions.

It order to obtain an accurate sum of fixed-precision floating-point numbers at high speed without adding significant modifications to existing resources, overflow and underflow of the upper-order bit values may be predicted in an algorithm for multiple-precision addition and subtraction. Such an arrangement makes it possible to obtain get_zz without relying on fi(x+y). In the disclosures of the present application, N represents a maximum width of a significand, and M represents a base in a numerical system.

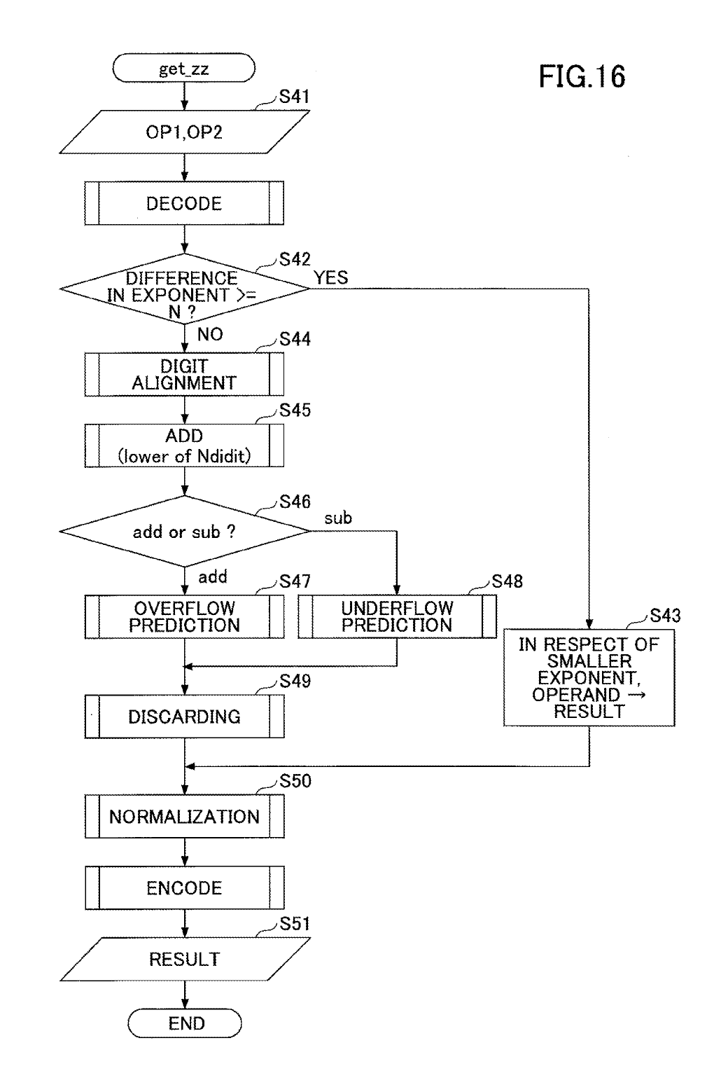

FIG. 16 is a drawing illustrating an example of the algorithm for get_zz. The procedure is as follows.

Data OP1 and OP2 represented in a floating-point number format are provided as inputs (step S41). The data format of the input data is not limited to any specific format, and the data do not have to be normalized. When a difference in exponents between OP1 and OP2 after normalization is N+1 or more (YES in step S42), a special process to provide an input to the normalization circuit through a bypass is performed. In so doing, one of the two inputs having a smaller exponent is supplied to the normalization circuit through the bypass (step S43).

When a difference in exponents between OP1 and OP2 after normalization is smaller than N+1 (NO in step S42), a digit alignment process is performed as a normal case. A difference in exponents between OP1 and OP2 is obtained, based on which the significand corresponding to the larger exponent is shifted to the left (step S44). Addition or subtraction is performed (step S45). In so doing, N digits from the LSB are extracted, and a result of subtraction or addition and a flag indicative of whether overflow or underflow has occurred are generated. This flag can be checked by use of a carry-out bit of the subtraction or addition.

When the process is addition (i.e., add in step S46), an overflow prediction process is performed (step S47).

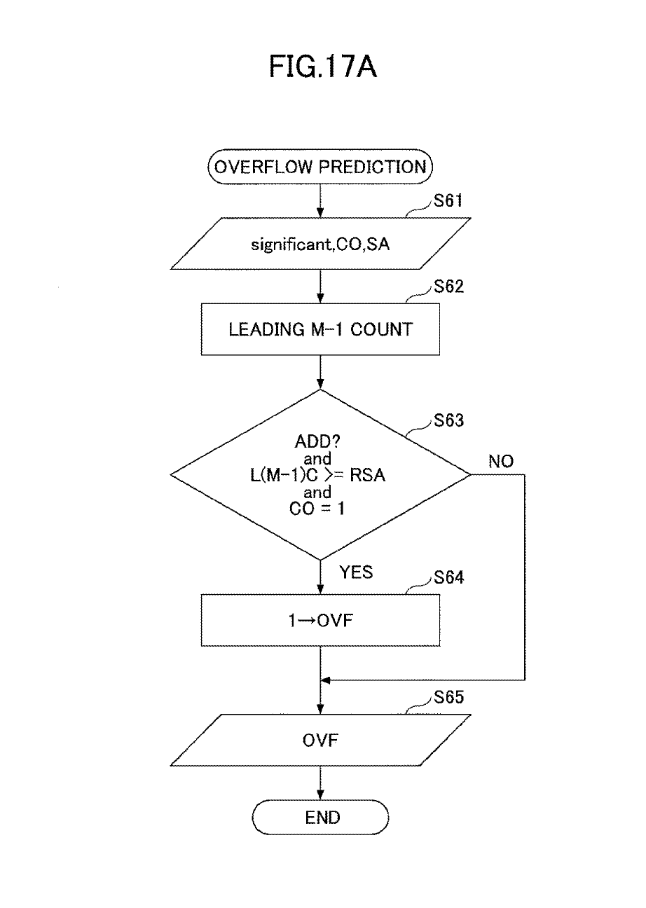

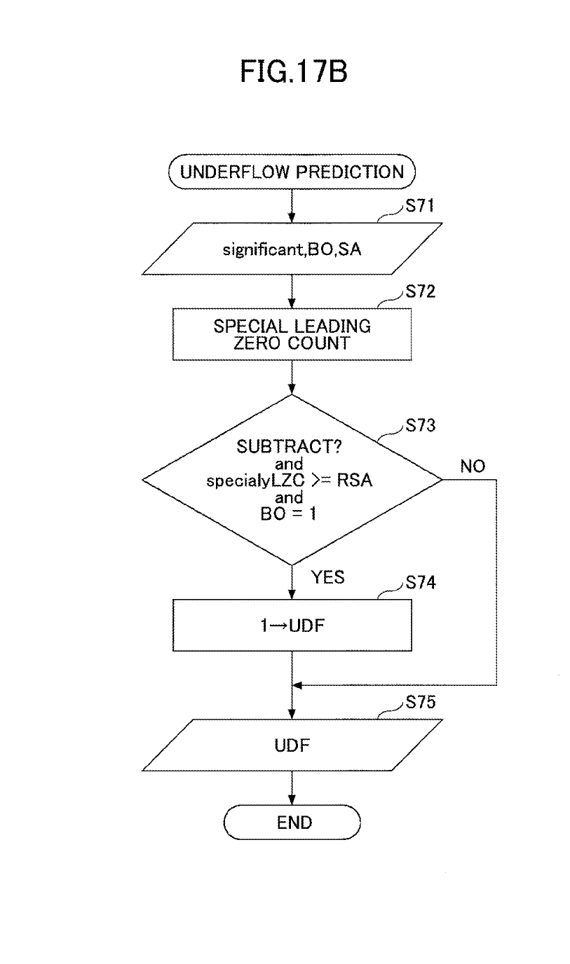

FIG. 17A is a flowchart illustrating an example of the overflow prediction process.

The following processes will be performed in the overflow prediction process. A significand corresponding to a larger exponent in OP1 and OP2, a flag CO indicative of whether overflow has occurred in the lower-order subtraction or addition process, and a shift amount SA for digit alignment are input (step S61). A leading M−1 counting process is performed (step S62). Here, “M−1” means a maximum number that does not create overflow, which is 1₂ in the case of a binary number and 1001₂ in the case of a binary coded decimal number, for example. When the leading M−1 count is larger than or equal to the shift amount for digit alignment and overflow has occurred in the lower-order subtraction and addition process (YES in step S63), the value “1” indicative of overflow is stored in the overflow flag (step S64), which is then output (step S65).

When the process is subtraction (i.e., sub in step S46), an underflow prediction process is performed (step S48).

FIG. 17B is a flowchart illustrating an example of the underflow prediction process.

The following processes will be performed in the underflow prediction process. A significand corresponding to a larger exponent in OP1 and OP2, a flag BO indicative of whether underflow has occurred in the lower-order subtraction or addition process, and a shift amount SA for digit alignment are input (step S71). A special leading zero counting process is performed (step S72). This process is a leading zero counting process in which counting does not stop upon encountering “1” the first time, but stops upon encountering “1” the second time.

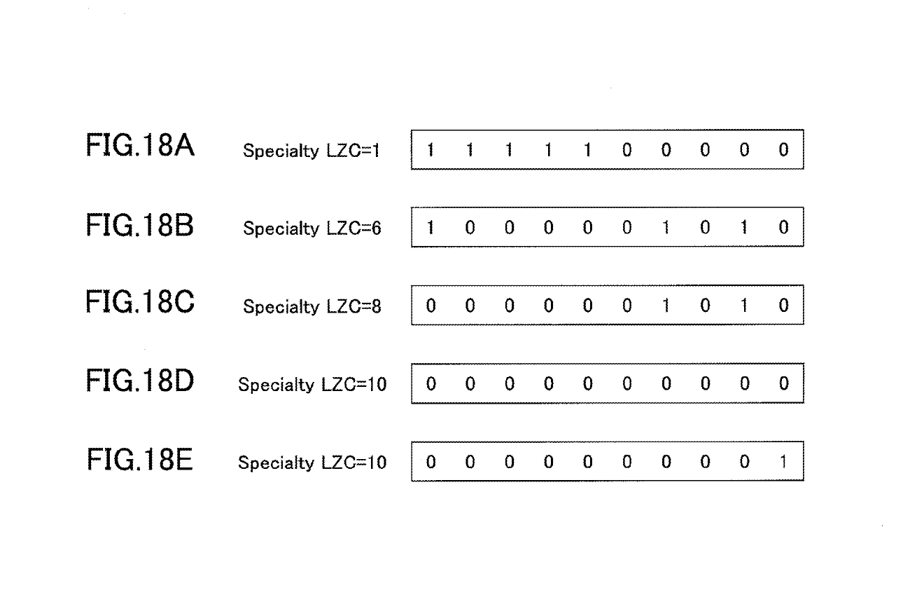

FIGS. 18A through 18E are drawing illustrating examples of the leading zero counting process. As illustrated in FIGS. 18A through 18E, the special leading zero counting process is performed such that successive bits of a significand are checked from the most significant bit when counting leading zeros in the significand, and “1” that appears the first time is regarded as “0” to continue the counting of zeros. In FIGS. 18A through 18E, “Specialty LZC” indicates the result of counting by the special leading zero counting process.

Returning to FIG. 17B, when the special leading zero count is larger than or equal to the shift amount for digit alignment and underflow has occurred in the lower-order subtraction and addition process (YES in step S73), the value “1” indicative of underflow is stored in the underflow flag (step S74), which is then output (step S75).

Returning to FIG. 16, a process to discard the digits that overlap between the result of upper-order addition and the result of lower-order addition is performed (step S49). This discarding process performs the following processes. The shift amount for discarding digits (i.e., discarding shift amount) is set equal to “N−the shift amount for digit alignment”. When the overflow flag is in the set state, the discarding shift amount is decreased by one. When the underflow flag is in the set state, the discarding shift amount is increased by one. Further, when the overflow flag is in the set state, the exponent is increased by two. When the underflow flag is in the set state, the exponent is decreased by two. Further, the significand is shifted to the left by the discarding shift amount.

Normalization is performed (step S50). In this normalization process, the bypassed exponent and significand are normalized in the case of the bypass select signal having been generated. In the case of no such bypass select signal having been generated, the exponent and significand obtained by the discarding process are normalized. At the conclusion, the result is output (step S51).

The overflow prediction algorithm utilizes the conditions under which overflow occurs. These conditions are as follows.

(a) Arithmetic is an addition operation (i.e., the signs of OP1 and OP2 are identical).
(b) The addition operation in get_zz creates overflow.
(c) A count indicative of the number of consecutive “M−1”s (“M−1” being 1₂ in the case of a binary number and 1001₂ in the case of a binary coded decimal number) from the MSB of the significand corresponding to the larger exponent is larger than or equal to the shift amount for digit alignment.

These conditions cover all the conditions in which a carry signal from a lower-order digit propagates to cause an overflow in fi(x+y), and also cover the case in which unnormalized numbers are input as OP1 and OP2.

When overflow occurs in fi (x+y), the overflow amount is always one digit. In the case of occurrence of overflow, thus, the shift amount for discarding overlapping digits on the get_zz side is decreased by one, which ensures that a correct result is always obtained under any overflow conditions. This is because the one-digit reduction in the shift amount for discarding overlapping digits is equivalent to the receipt of the MSB of the fi(x+y) side in the result of get_zz.

The digit-aligned significand corresponding to the larger exponent is denoted as T1, and the significand corresponding to the smaller exponent is denoted as T2. Further, N represents a digit width of an input significand, and SA represents a shift amount for digit alignment. G denotes a generate flag (i.e., a flag for generating a carry), and P denotes a propagate flag (i.e., a flag for propagating a carry). C is a carry. L(M−1)C is the number of consecutive “M−1”s (“M−1” being 1₂ in the case of a binary number and 1001₂ in the case of a binary coded decimal number) from the MSB. Further, N indicates the maximum digit width of the input significand, and M indicates a base, with i indicating an integer. A proof of the previously-noted conditions under which overflow occurs will be provided in the following.

The term “overflow” generally means that a value other than 0 is set in a digit that is higher than the highest digit of an adder. The formula for generating a carry in an addition operation is expressed as follows.

C[i]=G[i]+P[i]·G[i−1]+P[i]·P[i−1]·G[i−2]+ . . . +P[i]·P[i−1]·P[i−2] . . . P[0]Cin

Based on this, the following expressions are used.

C[i]=G[i]+P[i]·G[i−1]+P[i]·P[i−1]·G[i−2]+ . . . +P[i]·P[i−1]·P[i−2] . . . P[0]Cin

N′=N+SA

G[i]=(T₁[i]+T₂[i]>M−1)?1:0

P[i]=(T₁[i]+T₂[i]=M−1)?1:0

In this case, the formula for generating a carry-out bit in the upper-order addition is expressed as follows.

C[i]=G[i]+P[i]·G[i−1]+P[i]·P[i−1]·G[i−2]+ . . . +P[i]·P[i−1]·P[i−2] . . . P[0]Cin

C[N′−1]=G[N′−1]+P[N′−1]·G[N′−2]+P[N′−1]·P[N′−2]·G[N′−3]+ . . . +P[N′−1]·P[N′−2]·P[N′−3] . . . P[1]G[0]

When this carry-out bit is 1, a one-digit overflow occurs. In such a case, the following conditions are always satisfied.

C[i]=G[i]+P[i]·G[i−1]+P[i]·P[i−1]·G[i−2]+ . . . +P[i]·P[i−1]·P[i−2] . . . P[0]Cin

T₂[N′−1: N]=allzero

Thus, the following is obtained.

C[i]=G[i]+P[i]·G[i−1]+P[i]·P[i−1]·G[i−2]+ . . . +P[i]·P[i−1]·P[i−2] . . . P[0]Cin

G[N′−1:N]=allzero

P[N′−1:N]=(T₁[i]=M−1)?1:0

The formula for generating a carry-out bit for the lower-order addition is expressed as follows.

C[i]=G[i]+P[i]·G[i−1]+P[i]·P[i−1]·G[i−2]+ . . . +P[i]·P[i−1]·P[i−2] . . . P[0]Cin

C_{LO}=G[N−1]+P[N−1]·G[N−2]+P[N−1]·P[N−2]·G[N−3]+ . . . +P[N−1]·P[N−2]·P[N−3] . . . P[1]G[0]

This is used to sort out the formulas for generation.

C[i]=G[i]+P[i]·G[i−1]+P[i]·P[i−1]·G[i−2]+0 . . . +P[i]·P[i−1]·P[i−2] . . . P[0]Cin

C[N′−1]=P[N′−1]·P[N′−2]·P[N′−3]· . . . ·P[N]C_{LO}

The above-noted formulas for generation are thus obtained.

The following term is included in the formula for generating a carry-out bit in the upper-order addition.

P[N′−1]·P[N′−2]·P[N′−3]· . . . ·P[N]=1

This becomes 1 when the following condition is satisfied.

P[N′−1:N]=allzero

The number of zeros necessary in this case is SA=N′−N.

L(M−1)C{T₁}≧SA

The condition is satisfied when the above inequality is satisfied. The reason why the condition uses “≧” is because the values no greater than P[N−1] are included in the formula for generating a carry-out bit for the lower-order addition.

Overflow occurs only when the arithmetic is an addition operation (i.e., when the signs are the same). When the previously-noted conditions as follows are satisfied, thus, overflow occurs.

(a) The arithmetic is an addition operation.
(b) Overflow occurs in the lower-order addition operation (C_{LO}=1).
(c) A count indicative of the number of consecutive “M−1”s from the MSB of the significand corresponding to the larger exponent is larger than or equal to the shift amount for digit alignment (L(M−1)C{T₁}≧SA).

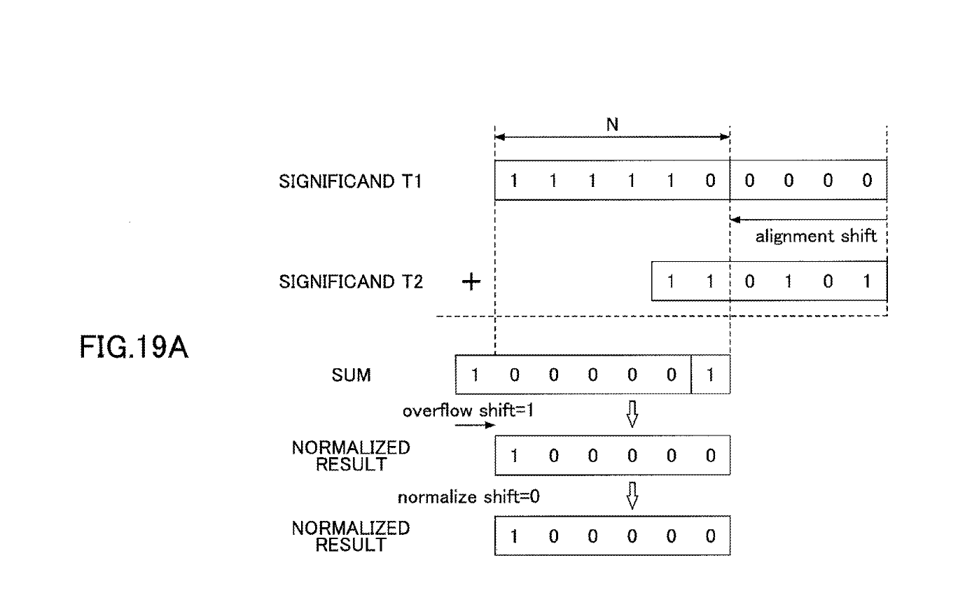

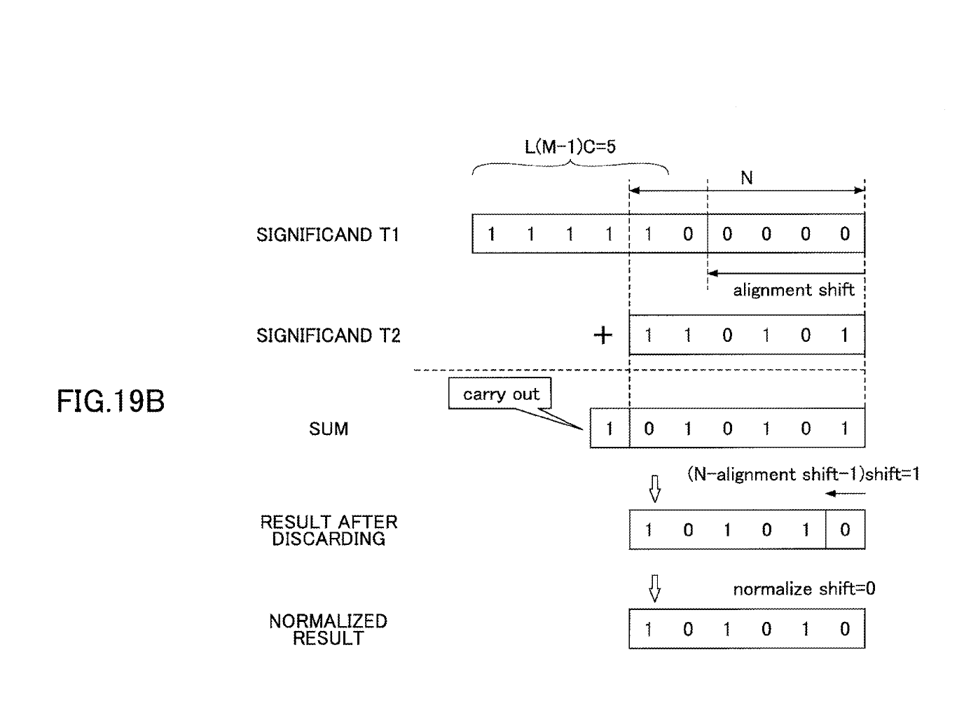

FIGS. 19A and 19B are drawings illustrating examples of fi(x+y) calculation and get_zz calculation in the case of occurrence of overflow in binary representation. The significand T1 corresponds to the larger exponent. The maximum width N of the significand is equal to 6. The difference in exponents (i.e., alignment shift) is equal to 4. The two significands are 111110₂ and 110101₂, respectively.

FIG. 19A illustrates an example of fi(x+y) calculation. The significand T1 is shifted to the left by the amount equal to the difference in exponents (1111100000). The significand T1 (1111100000) and the N upper-order digits (i.e., 6 digits) of the significand T2 (0000110101) are added to obtain the result of addition (1000001). As a result of the addition, overflow occurs so that a non-zero value is ejected from the width of N (i.e., 6) digits. The digits are shifted to the right by one digit for the ejected digit, thereby accommodating the number within the width of N (i.e., 6) digits. In this case, the LSB (which is equal to 1) ejected from fi(x+y) appears to be accommodated in the MSB of get_zz when only the result is taken into consideration. The result of addition is then normalized (i.e., shifted to the left by the amount equal to the leading zero count of the result of addition). The normalized result (100000) is thus obtained. The leading zero count in this example is zero, so that the shift amount is zero.

FIG. 19B is a drawing illustrating an example of get_zz calculation. The sign parts are checked to determine whether the arithmetic to be performed is an addition operation (i.e., the condition (a) for upper-order-side overflow). The significand T1 is shifted to the left by the amount equal to the difference in exponents (1111100000). The significand T1 (1111100000) and the N lower-order digits (i.e., 6 digits) of the significand T2 (0000110101) are added to obtain the result of addition (1010101). In so doing, there are digits that overlap between the lower-order side and the upper-order side. The addition of these overlapping portions will be used in the subsequent overflow process. As a result of addition, a carry-out bit is generated in the lower-order side, which corresponds to the relevant condition (i.e., the condition (b) for the upper-order-side overflow).

In order for an upper-order-side overflow to occur, the overflow of the condition (b) is supposed to propagate all the way to the most significant digit of the upper-order side. Accordingly, overflow occurs when M−1 is in existence in every digit from the digit at which the overflow in the lower-order side has occurred to the most significant digit. In other words, the fact that M−1 is in existence from the MSB of the significand T1 in as many digits as the number of the shift amount for digit alignment means that the condition is satisfied (i.e. L(M−1)C=5>the shift amount for digit alignment) (the condition (c)).

There are digits overlapping between the addition of the N lower-order digits and the addition of the N upper-order digits, so that shifting to the left by the number equal to (the maximum width of the significand−the shift amount for digit alignment) is performed to discard the overlapping digits. However, the fact that the conditions (a), (b), and (c) are satisfied indicates that overflow has occurred on the upper-order side. A digit is thus going to be moved from the upper-order side to the lower-order side. This digit corresponds to the LSB of the overlapping digits between the upper-order-side addition and the lower-order-side addition. In consideration of this, the amount of shift to the left as described above is decreased by one for balancing purposes (101010).

The result of addition is then normalized (i.e., shifted to the left by the amount equal to the leading zero count of the result of addition). The normalized result (101010) is thus obtained. The leading zero count in this example is zero, so that the shift amount is zero.

The underflow prediction algorithm utilizes the conditions under which underflow occurs. These conditions are as follows.

(a) Arithmetic is a subtraction operation (i.e., the signs of OP1 and OP2 are different).
(b) The subtraction operation in get_zz creates underflow.
(c) A count indicative of the number of leading zeros in the significand corresponding to the larger exponent, as obtained by regarding “1” appearing the first time as “0”, is larger than or equal to the shift amount for digit alignment.
These conditions cover all the conditions in which a borrow signal from a lower-order digit propagates to cause an underflow in at least one digit on the fi(x+y) side, and also cover the case in which unnormalized numbers are input as OP1 and OP2.

When underflow occurs in fi(x+y), the underflow amount is not limited to one digit. Regardless of the underflow amount, however, adding one to the shift amount for discarding overlapping digits ensures that a correct result is obtained under any conditions in which underflow occurs. This is because the occurrence of underflow in two or more digits is observed when the following condition is satisfied in addition to the previously-noted conditions.

(d) The shift amount for digit alignment is equal to one plus the leading zero count of the significand corresponding to the larger exponent as obtained by regarding “1” appearing the first time as “0”.
Namely, it appears that upon the occurrence of underflow in two or more digits, a corresponding number of digits need to be discarded from get_zz. Since the condition of (d) is required, however, this process is equivalent to the process of discarding all the digits from the result of get_zz. When the condition (d) is satisfied, there is only one digit left on the get_zz side even without considering underflow. Accordingly, discarding one digit is tantamount to discarding all the digits from the result of get_zz. It follows that the process is the same as or similar to the corresponding process in the case in which underflow only occurs in one digit.

Accordingly, there is no need to predict the case in which overflow occurs in two or more digits, and it suffices to predict only one case in which overflow occurs in at least one digit.

The digit-aligned significand corresponding to the larger exponent is denoted as T1, and the significand corresponding to the smaller exponent is denoted as T2. Further, N represents a digit width of an input significand, and SA represents a shift amount for digit alignment. G denotes a generate flag (i.e., a flag for generating a borrow), and P denotes a propagate flag (i.e., a flag for propagating a borrow). B is a borrow, and specialityLZC is the leading zero count as obtained by regarding “1” appearing the first time as “0”. An integer is denoted as i. A proof of the conditions in which underflow occurs in at least one digit and the conditions in which underflow occurs in two or more digits will be provided in the following.

The term “underflow” generally means that the most significant digit of the valid digits becomes zero when inputs are supplied to an adder.

B[i]=G[i]+P[i]·G[i−1]+P[i]·P[i−1]·G[i−2]+ . . . +P[i]·P[i−1]·P[i−2] . . . P[0]Cin

S[i]=T₁[i]−T₂[i]−B[i−1](when S[i]<0,S[i]=S[i]+M)

The above-noted expressions are given. Then, the number of leading zeros is counted in T₁, and the result is denoted as LZC{T₁}.

N′=N+SA

N″=N′−LZC{T₁}

G[i]=(T₁[i]−T₂[i]<0)?1:0

P[i]=(T₁[i]−T₂[i]=0)?1:0

When the above-noted expressions are given, the digit that has a value other than zero and appears the first time when checking successive digits from the MSB has a resulting value as follows.

B[N″−2]=G[N″−2]+P[N″−2]·G[N″−3]+P[N″−2]·P[N″−3]·G[N″−4]+ . . . +P[N″−2]·P[N″−3]·P[N″−4] . . . P[0]Cin

S[N″−1]=T₁[N″−1]−T₂[N″−1]−B[N″−2]

(when S[N″−1]<0, S[N″−1]=S[N″−1]+M)
When this result is 0, underflow occurs in at least one digit. In such a case, the following conditions are always satisfied.

T₂[N′−1:N]=allzero

Thus, the following is obtained.

G[N′−1:N]=allzero

P[N′−1:N]=(T₁[i]=0)?1:0

The formula for generating a borrow-out bit for the lower-order subtraction is expressed as follows.

B_{LO}=G[N−1]+P[N−1]·G[N−2]+P[N−1]·P[N−2]·G[N−3]+ . . . +P[N−1]·P[N−2]·P[N−3] . . . P[1]G[0]

This is used to sort out the formulas for generation.

B[N″−2]=P[N″−2]·P[N″−3]·P[N″−4]· . . . ·P[N]B_{LO}

S[N″−1]=T₁[N″−1]−B[N″−2]

when S[N″−1]<0, S[N″−1]=S[N″−1]+M)
The above-noted formulas for generation are thus obtained.

Since B[N″−2] can assume only a value of 0 or 1, T[N″−1] is equal to 1 in order for S[N″−1] to be zero. Accordingly, the conditions for underflow satisfy both of the following conditions.

T₁[N″−1]=1

B[N″−2]=1

The following term is included in the formula for generating a borrow-out bit in the upper-order-side subtraction.

P[N″−2]·P[N″−3]·P[N″−4]· . . . ·P[N]=1

This expression becomes 1 when the following condition is satisfied.

P[N″−2:N]=allzero

The number of zeros necessary in this case is N″−N−1=SA−LZC{T₁}−1.

T₁[N′−LZC{T₁}−1]=1

P[N″−2:N]=allzero

The two conditions noted above may be combined by use of specialityLZC{T₁} that is a special leading zero count as obtained by regarding “1” appearing the first time as “0” only once during the counting process.

specialityLZC{T₁}≧SA

The combined condition as noted above is thus obtained.

The reason why the condition uses “≧” is because the values no greater than P[N−1] are included in the formula for generating a carry-out bit for the lower-order subtraction. Underflow occurs only when the arithmetic is a subtraction operation (i.e., when the signs are different). When the previously-noted conditions as follows are satisfied, thus, underflow occurs.

(a) The arithmetic is a subtraction operation.
(b) Underflow occurs in the lower-order subtraction operation (B_{LO}=1).
(c) A count indicative of the number of consecutive zeros from the MSB of the significand corresponding to the larger exponent by regarding “1” appearing the first time as “0” only once during the counting process is larger than or equal to the shift amount for digit alignment (specialityLZC{T₁}≧SA).

In order for the upper-order-side subtraction to create underflow in D digits (D: an integer greater than or equal to 1), the following condition needs to be satisfied.

S[N″−1:N″−D]=allzero

In this case, the following conditions are known from the conditions for underflow occurring in at least one digit.

T₁[N″−1]=1

T₁[N″−2:N]=allzero

B[N″−2:N]=allone

S[N″−1]=0

In the case of D-digit underflow, the following expressions are taken into account.

B[i]=G[i]+P[i]·G[i−1]+P[i]·P[i−1]·G[i−2]+ . . . +P[i]·P[i−1]·P[i−2] . . . P[0]Cin

S[i]=T₁[i]−T₂[i]−B[i−1](when S[i]<0,S[i]=S[i]+M)

Based on the above-noted expressions, it is concluded that the following condition is sufficient.

−T₂[j]−1+M=0(N″−2≦j≦N″−D)

Namely, the following is the condition required for D-digit underflow.

T₂[N″−2:N″−D]=all M−1

The relationship between T₂ and the shift amount SA for digit alignment is as follows.

T₂[N′−1:N]=allzero

Because of this, SA>LZC{T₁}+2 results in T₂[N″−2] being equal to zero. This ends up breaking the conditions for M−1. If SA<LZC{T₁}+2 is satisfied, the arithmetic properly works only in the case of T2[N″−1]=0. Since B_{LO} is not generated, the relevant conditions are not satisfied. Accordingly, SA=LZC{T₁}+2 is the conditions for the occurrence of underflow in two or more digits. In such a case, T₁[N″−1]=1 is satisfied. Accordingly, the condition of SA=LZC{T₁}+2 can be rewritten into SA=specialityLZC{T₁}+1.

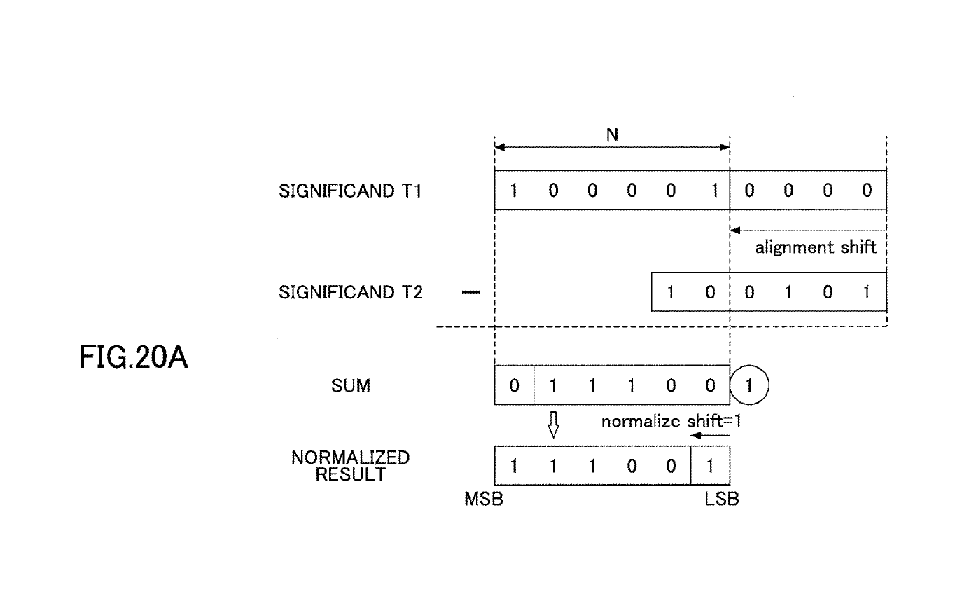

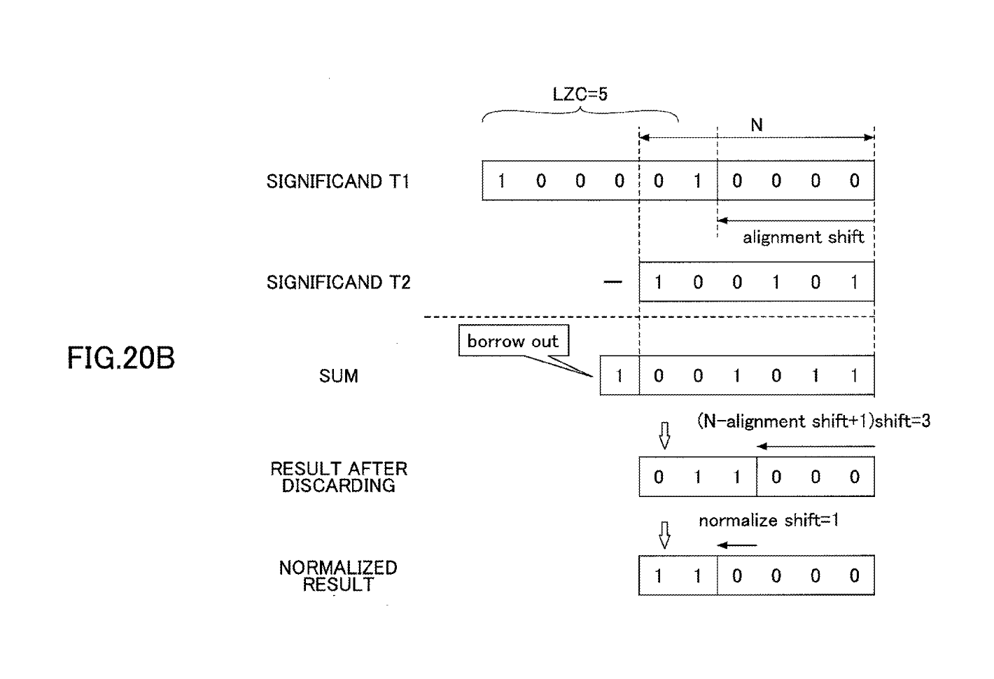

FIGS. 20A and 20B are drawings illustrating examples of fi(x+y) calculation and get_zz calculation in the case of occurrence of one-digit underflow in binary representation. The maximum width N of the significand is equal to 6. The difference in exponents (i.e., alignment shift) is equal to 4. The two significands are 100001₂ and 100101₂, respectively.

FIG. 20A illustrates an example of fi(x+y) calculation. The significand T1 is shifted to the left by the amount equal to the difference in exponents (1000010000). The significand T1 (1000010000) and the N upper-order digits (i.e., 6 digits) of the significand T2 (0000100101) are added to obtain the result of addition (011100).

The result of addition is then normalized (i.e., shifted to the left by the amount equal to the leading zero count of the result of addition). The normalized result (111001) is thus obtained. The leading zero count in this example is 1, so that a shift to the left by one digit is performed for normalization. The LSB obtained as the result of this operation is the digits that is discarded from the get_zz side. This fact is supposed to be reflected in the get_zz arithmetic for balancing purposes.

FIG. 20B is a drawing illustrating an example of get_zz calculation. The sign parts are checked to determine whether the arithmetic to be performed is a subtraction operation (i.e., the condition (a) for upper-order-side underflow). The significand T1 is shifted to the left by the amount equal to the difference in exponents (1000010000). The significand T1 (1000010000) and the N upper-order digits (i.e., 6 digits) of the significand T2 (0000100101) are added to obtain the result of addition (1001011). In so doing, there are digits that overlap between the lower-order side and the upper-order side. The addition of these overlapping portions will be used in the subsequent overflow process. As a result of addition, a borrow-out bit is generated in the lower-order side, which corresponds to the relevant condition (i.e., the condition (b) for the upper-order-side underflow).

In order for an upper-order-side underflow to occur, the underflow of the condition (b) is supposed to propagate all the way to the most significant digit of the upper-order side. Accordingly, underflow occurs when the most significant digit of the valid digits is 1 and zero is in existence in every digit from the digit at which the underflow in the lower-order side has occurred to the most significant digit of the valid digits. In other words, the fact that zero is in existence from the MSB of the significand T1 in as many digits as the number of the shift amount for digit alignment (as counted by regarding “1” appearing the first time as “0”) means that the condition is satisfied (i.e. specialityLZC=5>the shift amount for digit alignment (the condition (c) for upper-digit-side underflow)).

There are digits overlapping between the addition of the N lower-order digits and the addition of the N upper-order digits, so that shifting to the left by the number equal to (the maximum width of the significand−the shift amount for digit alignment) is performed to discard the overlapping digits. However, the fact that the conditions (a), (b), and (c) are satisfied indicates that underflow has occurred on the upper-order side. A digit is thus going to be discarded from the lower-order side. This value corresponds to the MSB of the lower-order-digit side. In consideration of this, the amount of shift to the left as described above is increased by one for balancing purposes (011000).

The result of addition is then normalized (i.e., shifted to the left by the amount equal to the leading zero count of the result of addition). The normalized result (110000) is thus obtained. The leading zero count in this example is 1, so that a shift to the left by one digit is made.

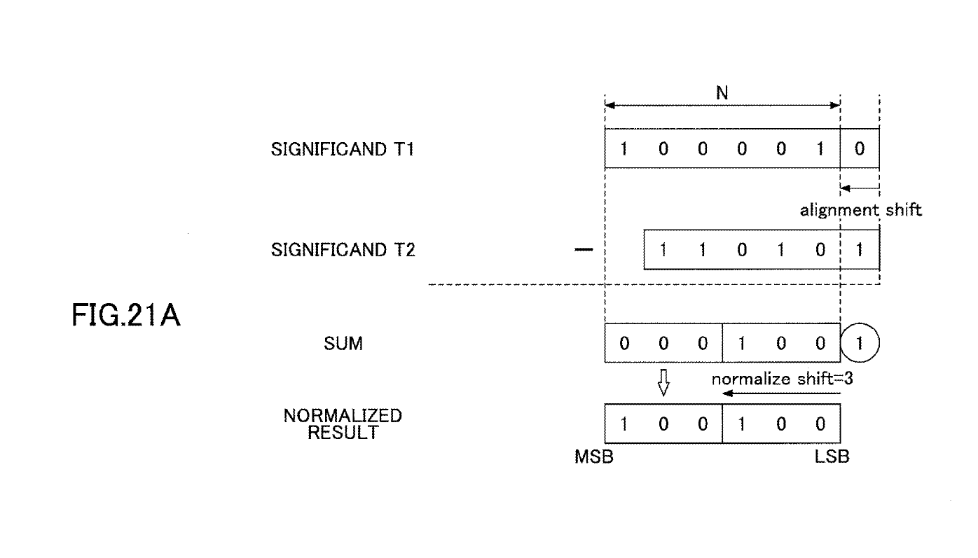

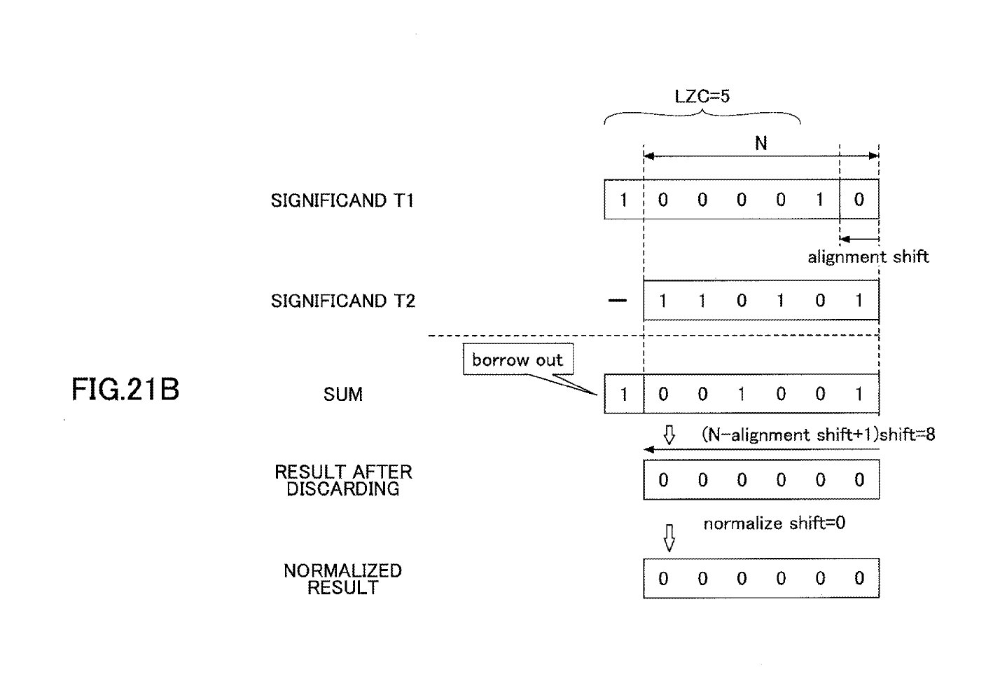

FIGS. 21A and 21B are drawings illustrating examples of fi(x+y) calculation and get_zz calculation in the case of occurrence of three-digit underflow in binary representation. The maximum width N of the significand is equal to 6. The difference in exponents (i.e., alignment shift) is equal to 4. The two significands are 100001₂ and 1101012, respectively.

FIG. 21A illustrates an example of fi(x+y) calculation. The significand T1 is shifted to the left by the amount equal to the difference in exponents (1000010). The significand T1 (1000010) and the N upper-order digits (i.e., 6 digits) of the significand T2 (0110101) are added to obtain the result of addition (000100).

The result of addition is then normalized (i.e., shifted to the left by the amount equal to the leading zero count of the result of addition). The normalized result (100100) is thus obtained. The leading zero count in this example is 3, so that a shift to the left by three digits is performed for normalization. The LSB obtained as the result of this operation is the digit that is discarded from the get_zz side. This fact is supposed to be reflected in the get_zz arithmetic for balancing purposes.

FIG. 21B is a drawing illustrating an example of get_zz calculation. The sign parts are checked to determine whether the arithmetic to be performed is a subtraction operation (i.e., the condition (a) for upper-order-side underflow). The significand T1 is shifted to the left by the amount equal to the difference in exponents (1000010). The significand T1 (1000010) and the N upper-order digits (i.e., 6 digits) of the significand T2 (0110101) are added to obtain the result of addition (1001001). In so doing, there are digits that overlap between the lower-order side and the upper-order side. The addition of these overlapping portions will be used in the subsequent overflow process. As a result of addition, a borrow-out bit is generated in the lower-order side, which corresponds to the relevant condition (i.e., the condition (b) for the upper-order-side underflow).

In order for an upper-order-side underflow to occur, the underflow of the condition (b) is supposed to propagate all the way to the most significant digit of the upper-order side. Accordingly, underflow occurs when the most significant digit of the valid digits is 1 and zero is in existence in every digit from the digit at which the underflow in the lower-order side has occurred to the most significant digit of the valid digits. In other words, the fact that zero is in existence from the MSB of the significand T1 in as many digits as the number of the shift amount for digit alignment (as counted by regarding “1” appearing the first time as “0”) means that the condition is satisfied (i.e. specialityLZC=5>the shift amount for digit alignment (the condition (c) for upper-digit-side underflow)).

Since underflow has occurred in three digits on the upper-order side, as a principle, three digits are supposed to be also discarded from the lower-order side. Because the difference in exponents is only 1, however, the result of the lower-order side has zeros in digits other than the MSB. Discarding one digit of the MSB from the lower-order side is thus equivalent to discarding three digits. Since the conditions (a), (b), and (c) are satisfied, “the maximum width of the significand−the shift amount for digit alignment+1” is shifted to the left to obtain the result (000000).

The result of addition is then normalized (i.e., shifted to the left by the amount equal to the leading zero count of the result of addition). The normalized result (000000) is thus obtained. Since all the digits of the result are zeros in this example, all the digits remain to be zeros even after the shift operation.

With the above-described arithmetic method, an accurate sum of fixed-precision floating-point numbers is obtained at high speed without adding significant modifications to existing resources. This algorithm for obtaining an accurate sum is frequently used in order to implement multiple-precision or variable-precision floating-point arithmetic when such an arithmetic is implemented by use of fixed-precision floating-point arithmetic. The speed increase achieved by the above-noted arithmetic method thus leads to a speed increase in floating-point number arithmetic in general.

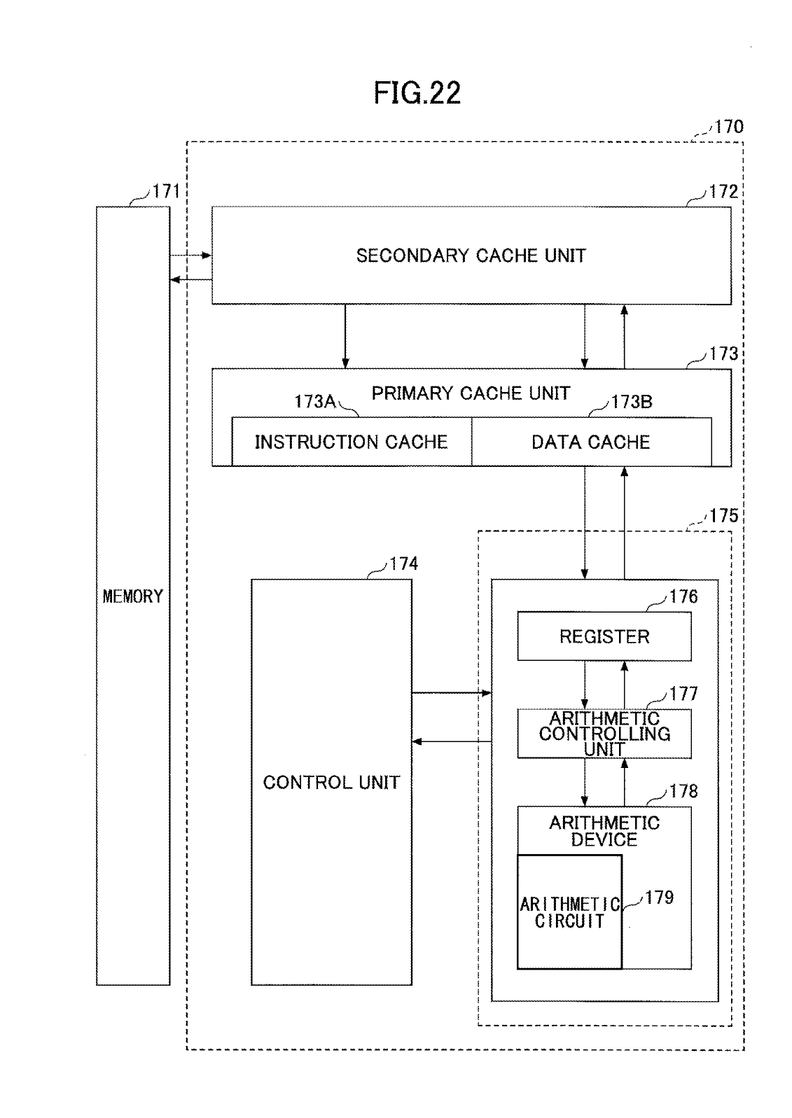

FIG. 22 is a drawing illustrating an example of the configuration of a computer system. The computer system illustrated in FIG. 22 includes a processor 170 and a memory 171. The processor 170 serving as a processor includes a secondary cache unit 172, a primary cache unit 173, a control unit 174, and an arithmetic unit 175. The primary cache unit 173 includes an instruction cache 173A and a data cache 173B. The arithmetic unit 175 includes a register 176, an arithmetic controlling unit 177, and an arithmetic device 178. The arithmetic device 178 includes an arithmetic circuit 179. In FIG. 22 and the subsequent drawings, boundaries between functional blocks illustrated as boxes basically indicate functional boundaries, and may not correspond to separation in terms of physical positions, separation in terms of electrical signals, separation in terms of control logic, etc. Each functional block may be a hardware module that is physically separated from other blocks to some extent, or may indicate a function in a hardware module in which this and other blocks are physically combined together. Each functional block may be a module that is logically separated from other blocks to some extent, or may indicate a function in a module in which this and other blocks are logically combined together.

The above-noted computer system is an exemplified information processing apparatus utilizing a CPU (central processing unit), and is used to implement hardware for performing arithmetic on Oracle-numbers. In the processor 170, the cache memory system is implemented as having a multilayer structure in which the primary cache unit 173 and the secondary cache unit 172 are provided. Specifically, the secondary cache unit 173 that can be accessed faster than the main memory is situated between the primary cache unit 172 and the main memory (i.e., the memory 171). With this arrangement, the frequency of access to the main memory upon the occurrence of cache misses in the primary cache unit 173 is reduced, thereby lowering cache-miss penalty.

The control unit 174 issues an instruction fetch address and an instruction fetch request to a primary instruction cache 173A to fetch an instruction from this instruction fetch address. The control unit 174 controls the arithmetic unit 175 in accordance with the decode results of the fetched instruction to execute the fetched instruction. The arithmetic controlling unit 177 operates under the control of the control unit 174 to supply data to be processed from the register 176 to the arithmetic device 178 and to store processed data in the register 176 at a specified register location. Further, the arithmetic controlling unit 177 specifies the type of arithmetic performed by the arithmetic device 178. Moreover, the arithmetic controlling unit 177 specifies an address to be accessed to perform a load instruction or a store instruction with respect to this address in the primary cache unit 173. Data read from the specified address by the load instruction is stored in the register 176 at a specified register location. Data stored at a specified location in the register 176 is written to the specified address by the store instruction. The arithmetic circuit 179 included in the arithmetic device 178 serves to obtain an accurate sum of floating-point numbers as previously described.

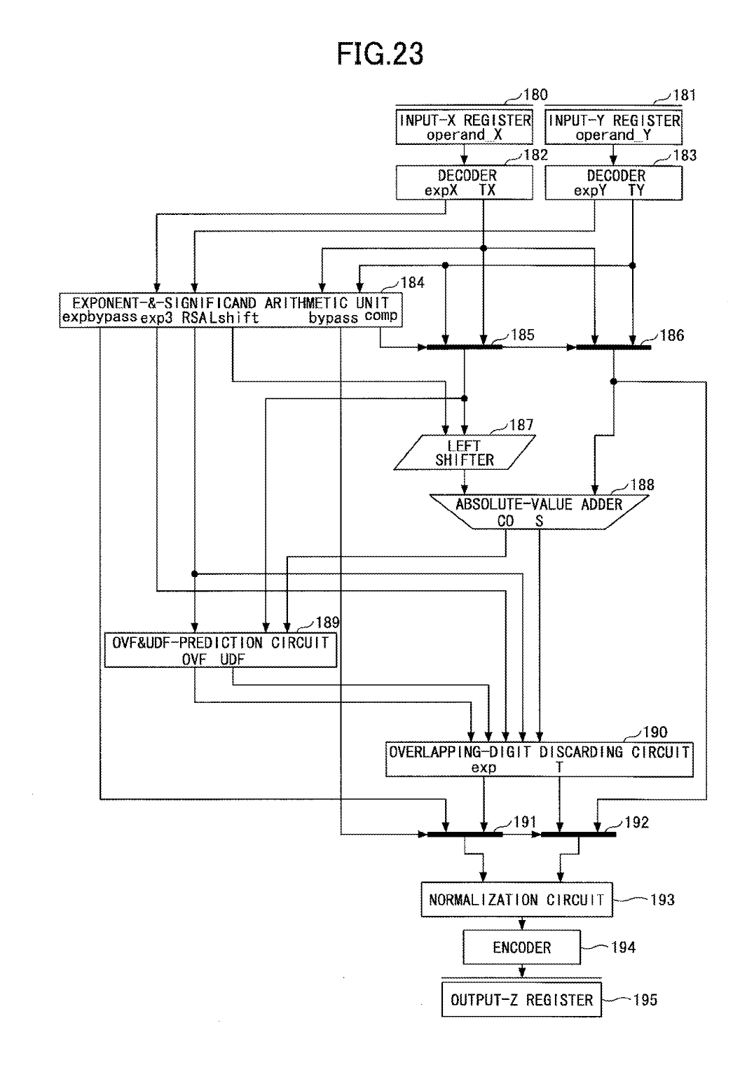

FIG. 23 is a drawing illustrating an example of the configuration of a get_zz arithmetic device that processes floating-point decimal numbers in the 8-byte-width Oracle-number format. Although floating-point decimal numbers in the 8-byte-width Oracle-number format are used as an example in the descriptions, the decode circuit and the encode circuit may be redesigned such that the disclosed configuration may be usable for both the Oracle-number format and another format. The get_zz arithmetic device illustrated in FIG. 23 includes an input-X register 180, an input-Y register 181, decoders 182 and 183, an exponent-&-significand arithmetic unit 184, selectors 185 and 186, a left shifter 187, an absolute-value adder 188, an OVF&UDF-prediction circuit 189, and an overlapping-digit discarding circuit 190. The get_zz arithmetic device further includes selectors 191 and 192, a normalization circuit 193, an encoder 194, and an output-Z register 195.

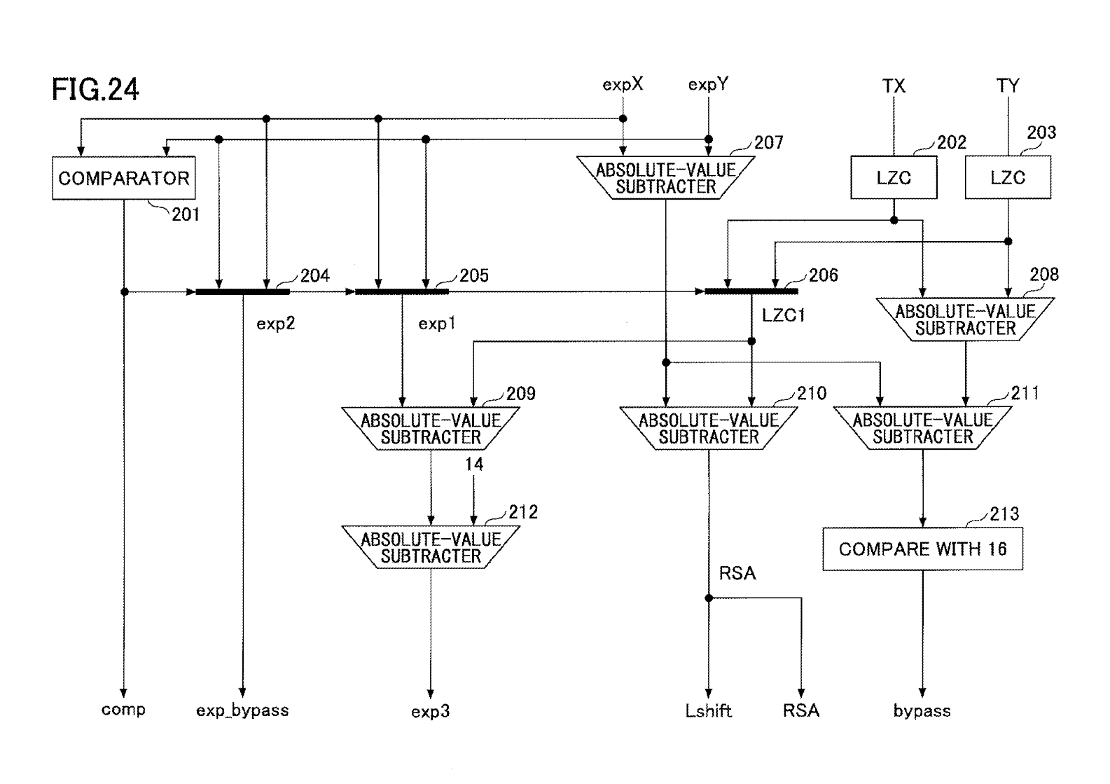

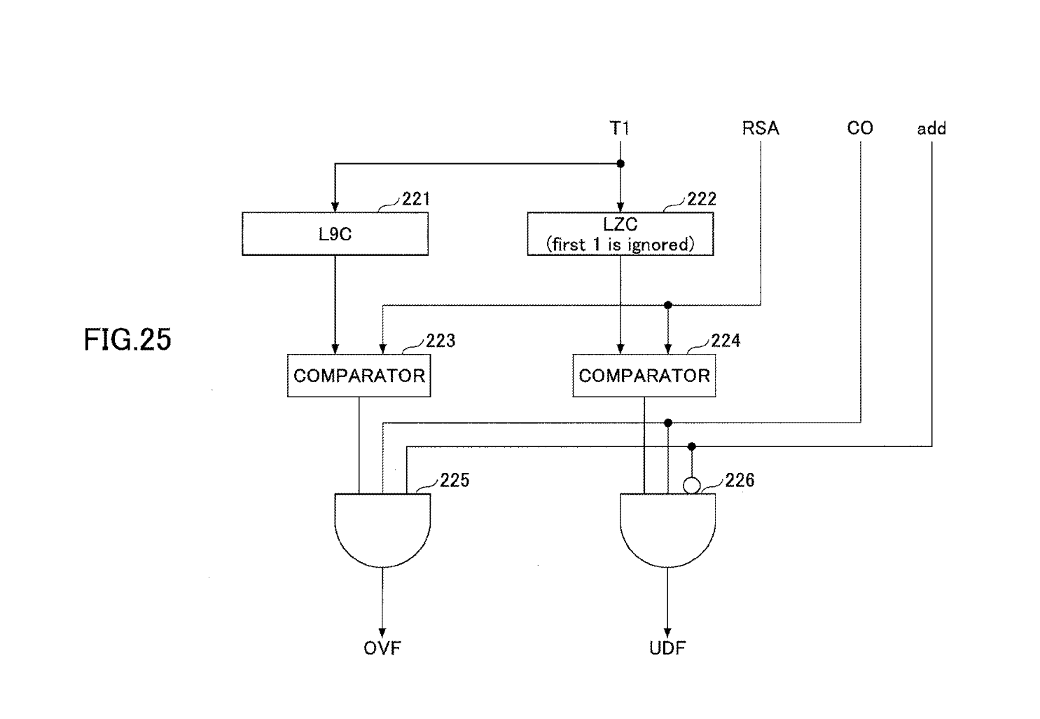

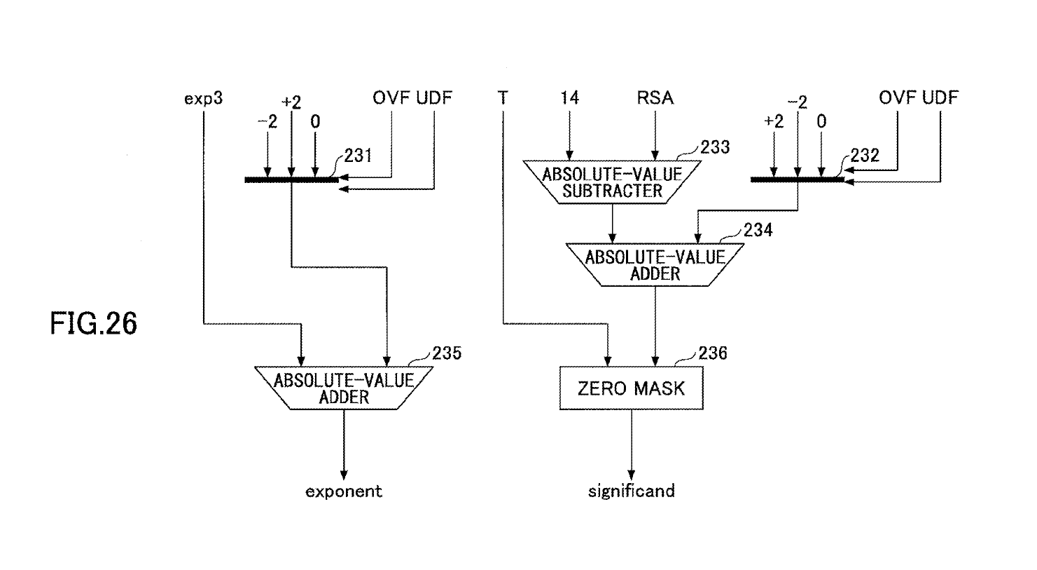

FIG. 24 is a drawing illustrating an example of the configuration of the exponent-&-significand arithmetic unit 184 of the get_zz arithmetic device illustrated in FIG. 23. The exponent-&-significand arithmetic unit 184 includes a comparator 201, LZC counters 202 and 203, selectors 204 through 206, absolute-value subtracters 207 through 212, and a comparator 213. FIG. 25 is a drawing illustrating an example of the configuration of the OVF&UDF-prediction circuit 189 of the get_zz arithmetic device illustrated in FIG. 23. The OVF&UDF-prediction circuit 189 includes an L9C circuit 221 for counting nine leading items, an LZC counter 222, comparators 223 and 224, and AND gates 225 and 226. FIG. 26 is a drawing illustrating an example of the configuration of the overlapping-digit discarding circuit 190 of the get_zz arithmetic device illustrated in FIG. 23. The normalization circuit 190 includes selectors 231 and 232, a subtracter 233, adders 234 and 235, and a zero-mask circuit 236.

In FIG. 23, the inputs and the output are floating-point numbers having the same precision. The input data may or may not be normalized, and the output data is normalized without exception. In the Oracle-number format, the exponent is always an even number. The previously noted algorithm is modified accordingly. For example, the addition and subtraction operations for the discarding processing amount at the time of overflow and underflow are changed from “+1” and “−1” to “+2” and “−2”.

Further, in the algorithm previously described, a flag indicative of whether the lower-order-side addition creates overflow or underflow has been used. In hardware implementation, however, a divisor is converted into a two's complement during a subtraction operation, and an addition operation is performed. In consideration of this, a flag indicative of overflow and a flag indicative of underflow are both referred to by the term “carry-out”.

Moreover, in the description of the algorithm as previously provided, a shift operation is performed to discard overlapping digits, so that a total of two shift operations are performed when taking into account a shift operation for normalization. In the present embodiment, one zero-mask operation and one shift operation are used to implement a process equivalent to the two shift operations, thereby reducing the number of logic stages.

In the following, the operation of the get_zz arithmetic device illustrated in FIG. 23 through FIG. 26 will be described.

Data are supplied to the decoder 182 and the decoder 183 from the input-X register 180 and the input-Y register 181, respectively. Each of the decoders 182 and 183 divides an input into a sign, an exponent, and a significand, thereby converting the input into an internal format. The sign, exponent, and significand of the inputs X and Y are referred to as a sign-X, an exponent-X (expX), and a significand-X (TX), and a sign-Y, an exponent-Y (expY), and a significand-Y (TY), respectively.

The exponent-&-significand arithmetic unit 184 receives the exponent-X, the significand-X, the exponent-Y, and the significand-Y. The comparator 201 of the exponent-&-significand arithmetic unit 184 compares the exponent-X and the exponent-Y in terms of their magnitudes, and generates a select signal such that the significand associated with the larger exponent, which will be denoted as exp1, serves as a significand T1, and that the significand associated with the smaller exponent, which will be denoted as exp2, serves as a significand T2.

The absolute-value subtracter 211 and the comparator 213 of the exponent-&-significand arithmetic unit 184 perform an arithmetic for providing a bypass from an input to the normalization circuit 193 when the absolute value of {(exponent-X−the count indicative of the number of leading zeros in significand-X)−(exponent-Y−the count indicative of the number of leading zeros in significand-Y)} is larger than or equal to 16. The exponent-&-significand arithmetic unit 184 generates a select signal such that the significand T2 and the sign and exponent associated therewith are bypassed, and also outputs an exponent to be bypassed.

The absolute-value subtracter 210 of the exponent-&-significand arithmetic unit 184 calculates (exponent exp1−exponent exp2−the count indicative of the number of leading zeros in significand T1), and outputs the calculated value as a shift amount RSA. When the leading zero count of the significand T1 is an odd number, this number is decreased by 1. The absolute-value subtracter 209 of the exponent-&-significand arithmetic unit 184 subtracts the leading zero count of the significand T1 from the exponent exp 1, and the absolute-value subtracter 212 calculates an exponent exp3 that is the result of subtracting 14 from the output of the absolute-value subtracter 139. The exponent exp3 is then supplied to the overlapping-digit discarding circuit 190.

The exponent-&-significand arithmetic unit 184 supplies the shift amount RSA to the left shifter 187 and the overlapping-digit discarding circuit 190. The left shifter 187 shifts the supplied significand to the left according to the supplied shift amount. The significand T1 shifted to the left and the 14 lower-order digits (i.e., 56 bits) of the significand T2 without being shifted are supplied to the absolute-value adder 188. In the case of subtraction, the significand of a subtrahend is inverted to generate one's complement, which is supplied as an input, with “1” being supplied as a carry bit to the absolute-value adder 188. The absolute-value adder 188 adds up the 14 lower-order digits (i.e., 56 bits) of inputs, and supplies the result to the overlapping-digit discarding circuit 190. Also, the carry-out bit is supplied from the absolute-value adder 188 to the OVF&UDF-prediction circuit 189.

The OVF&UDF-prediction circuit 189 receives the significand T1, the shift amount RSA, and the carry-out bit of the result of addition. The OVF&UDF-prediction circuit 189 predicts overflow. The L9C circuit 221 of the OVF&UDF-prediction circuit 189 counts the number of consecutive 9s (1001₂) from the most significant digit of the significand T1. The comparator 223 and the AND gate 225 generate a flag indicative of the occurrence of overflow when the counted number of 9s is larger than the shift amount RSA, the carry-out bit is generated, and the arithmetic is an addition operation. The flag is supplied to the overlapping-digit discarding circuit 190.

Further, the OVF&UDF-prediction circuit 189 predicts underflow. The LZC counter 222 of the OVF&UDF-prediction circuit 189 performs special leading zero counting. The comparator 224 and the AND gate 226 generate a flag indicative of the occurrence of underflow when the counted number of zeros is larger than the shift amount RSA, the carry-out bit is generated, and the arithmetic is a subtraction operation. The flag is supplied to the overlapping-digit discarding circuit 190.

The overlapping-digit discarding circuit 190 receives the result of addition from the absolute-value adder 188, the exponent exp3 and the shift amount RSA from the exponent-&-significand arithmetic unit 184, as well as the overflow flag and the underflow flag from the OVF&UDF-prediction circuit 189. The subtracter 233 of the overlapping-digit discarding circuit 190 calculates (14×(digit width of the significand)−shift amount RSA), and sets the mask amount equal to the calculated value. The adder 234 decreases the mask amount by two when the overflow flag is in the set state, and increases the mask amount by two when the underflow flag is in the set state. Further, the mask amount is set equal to zero upon detecting that the mask amount has become a negative number. The adder 235 of the overlapping-digit discarding circuit 190 increases the exponent exp3 by two when the overflow flag is in the set state, and decreases the exponent exp3 by two when the underflow flag is in the set state.

The zero-mask circuit 236 of the overlapping-digit discarding circuit 190 masks a certain number of digits of the upper-order digits of the significand where the certain number is equal to the mask amount.

In the case of the bypass select signal to the normalization circuit 193 being 1, the bypassed significand and exponent are supplied to the normalization circuit 193. In the case of the bypass select signal to the normalization circuit 193 being 0, the significand and exponent output from the overlapping-digit discarding circuit 190 are supplied to the normalization circuit 193.

The normalization circuit 193 (which may have the same configuration as in FIG. 15) counts the number of leading zeros in the significand. When the leading zero count is an odd number, the correction unit decreases the leading zero count by one. The normalization circuit 193 subtracts the leading zero count of the significand from the exponent, and sets the result to the exponent-Z. The normalization circuit 193 shifts the significand to the left by the amount equal to the leading zero count of the significand, and sets the result to the exponent-Z.

The encoder 194 converts the sign, the exponent-Z, and the significand-Z into an external format for provision to the output-Z register 195.

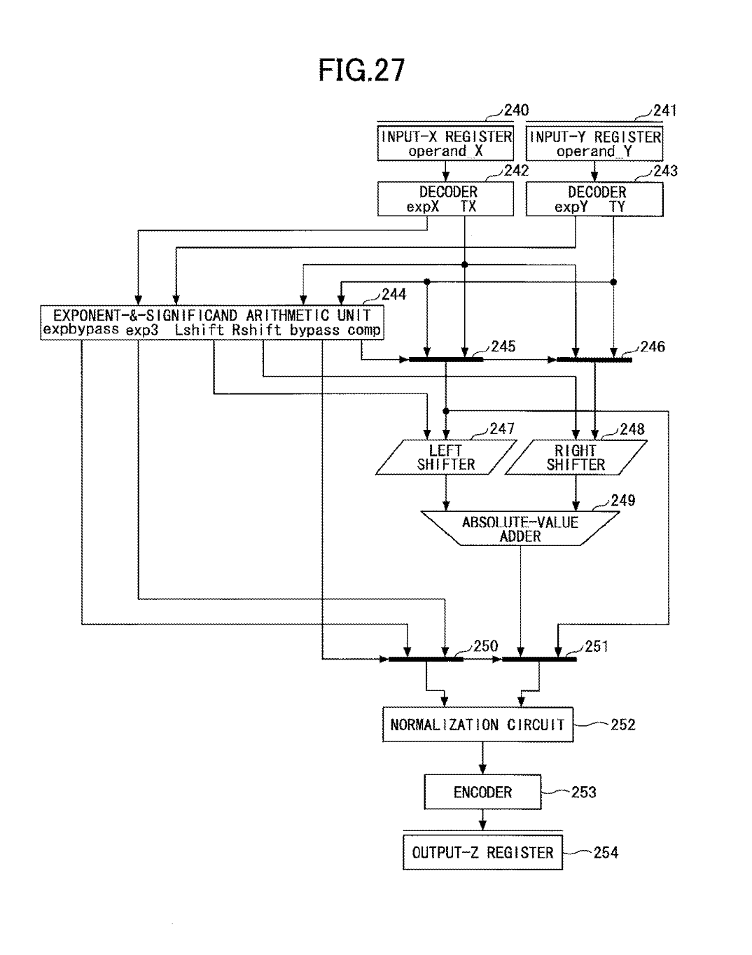

FIG. 27 is a drawing illustrating an example of the configuration of a fi(x+y) arithmetic device that processes floating-point decimal numbers in the 8-byte-width Oracle-number format. The fi(x+y) arithmetic device illustrated in FIG. 27 includes an input-X register 240, an input-Y register 241, decoders 242 and 243, an exponent-&-significand arithmetic unit 244, selectors 245 and 246, a left shifter 247, a right shifter 248, an absolute-value adder 249, selectors 250 and 251, and a normalization circuit 252. The fi(x+y) arithmetic device further includes an encoder 253 and an output-Z register 254. It may be noted that the fi(x+y) arithmetic device illustrated in FIG. 27 is equal to the fi(x+y) arithmetic device illustrated in FIG. 9 minus the circuit portion (i.e., the output OVF&UDF-count register 75 and the relevant paths) that relates to the counting of overflow and underflow. The configuration and operation of each part of the fi(x+y) arithmetic device illustrated in FIG. 27 are the same as the configuration and operation of a corresponding part of the fi(x+y) arithmetic device illustrated in FIG. 9. In the following, these operations will be described.

Data are supplied to the decoder 242 and the decoder 243 from the input-X register 240 and the input-Y register 241, respectively. Each of the decoders 242 and 243 divides an input into a sign, an exponent, and a significand, thereby converting the input into an internal format. The sign, exponent, and significand of the inputs X and Y are referred to as a sign-X, an exponent-X (expX), and a significand-X (TX), and a sign-Y, an exponent-Y (expY), and a significand-Y (TY), respectively.

The exponent-&-significand arithmetic unit 244 receives the exponent-X, the significand-X, the exponent-Y, and the significand-Y. The exponent-&-significand arithmetic unit 244 compares the exponent-X and the exponent-Y in terms of their magnitudes, and generates a select signal such that the significand associated with the larger exponent, which will be denoted as exp1, serves as a significand T1, and that the significand associated with the smaller exponent, which will be denoted as exp2, serves as a significand T2.

The exponent-&-significand arithmetic unit 244 perform an arithmetic for providing a bypass from an input to the normalization circuit 252 when the absolute value of {(exponent-X−the count indicative of the number of leading zeros in significand-X)−(exponent-Y−the count indicative of the number of leading zeros in significand-Y)} is larger than or equal to 16. The exponent-&-significand arithmetic unit 244 generates a select signal such that the significand T1 and the sign and exponent associated therewith are bypassed, and also outputs an exponent to be bypassed.

The exponent-&-significand arithmetic unit 244 sets a shift amount LSA1 equal to a value of (exp1−exp2). The exponent-&-significand arithmetic unit 244 sets a shift amount LSA2 equal to the leading zero count of the significand T1 (i.e., the number of leading zeros in the significand T1). In the case of the count being an odd number, however, the count is decreased by one. The exponent-&-significand arithmetic unit 244 calculates (exponent exp1−exponent exp2−the count indicative of the number of leading zeros in significand T1), and outputs the calculated value as a shift amount RSA. When the leading zero count of the significand T1 is an odd number, this number is decreased by 1. The exponent-&-significand arithmetic unit 244 compares LSA1 with LSA2 to detect which one is larger. In response to the result of comparison, LSA2 is selected in the case of LSA1 being smaller, and LSA1 is selected in the case of LSA1 being larger, followed by outputting the selected one as LSA. The exponent-&-significand arithmetic unit 244 calculates an exponent exp3 that is the result of subtracting the leading zero count of the significand T1 from the exponent exp 1, and supplies the exponent exp3 to the normalization circuit 252.

The exponent-&-significand arithmetic unit 244 supplies the shift amount RSA to the right shifter 248 and the shift amount LSA to the left shifter 247. The left shifter 247 shifts the supplied significand to the left according to the supplied shift amount. The right shifter 248 shifts the supplied significand to the right according to the supplied shift amount. The significand T1 shifted to the left and the significand T2 shifted to the right are supplied to the absolute-value adder 249. In the case of subtraction, the significand of a subtrahend is inverted to generate one's complement, which is supplied as an input, with “1” being supplied as a carry bit to the absolute-value adder 249. The absolute-value adder 249 adds up the inputs, and supplies the result to the normalization circuit 252.

In the case of the bypass select signal to the normalization circuit 252 being 1, the bypassed significand and exponent are supplied to the normalization circuit 252. In the case of the bypass select signal to the normalization circuit 252 being 0, the result of addition and the exponent exp3 are supplied to the normalization circuit 252 as a significand and an exponent, respectively.

The normalization circuit 252 subtracts the leading zero count of the significand from the exponent, and sets the result to the exponent-Z. The normalization circuit 252 shifts the addition result to the left by the amount equal to the leading zero count of the significand, and sets the result to the exponent-Z.

The encoder 253 converts the sign, the exponent-Z, and the significand-Z into an external format for provision to the output-Z register 254.

FIG. 23 and FIG. 27 described above illustrate a circuit configuration in which the get_zz arithmetic device and the fi(x+y) arithmetic device are provided separately from each other. This circuit configuration may be redesigned such that the get_zz arithmetic device and the fi(x+y) arithmetic device share some circuit portions.

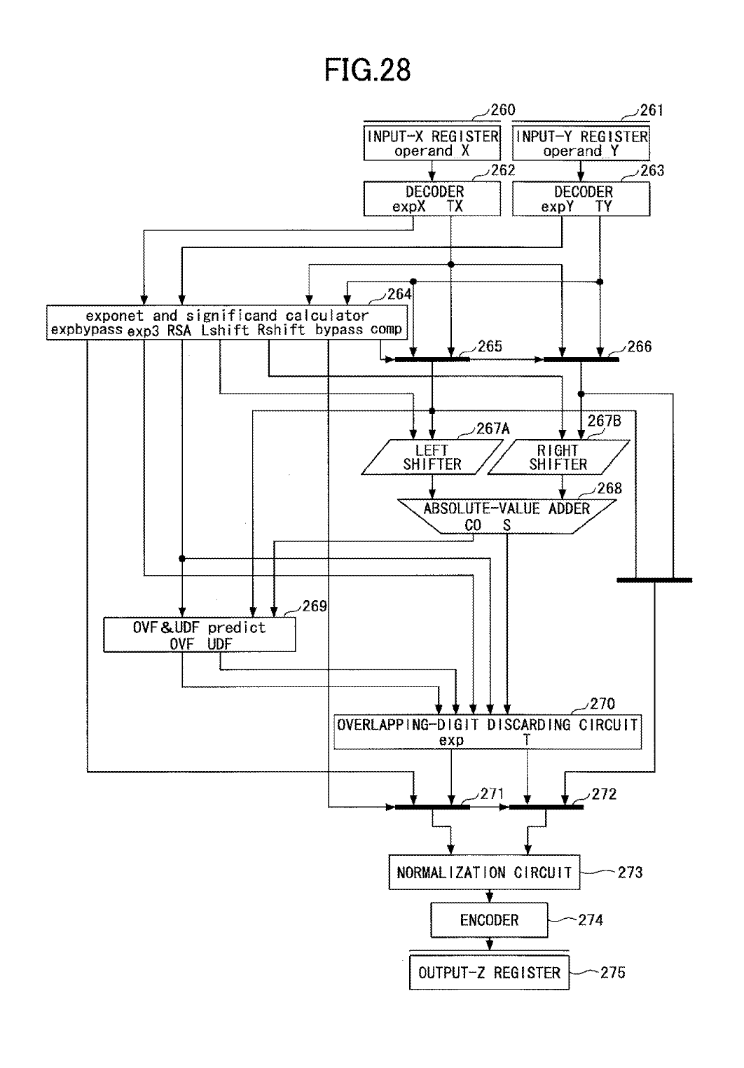

FIG. 28 is a drawing illustrating an example of the configuration of an arithmetic device that can perform both the get_zz arithmetic and the fi(x+y) arithmetic. The arithmetic device illustrated in FIG. 28 includes an input-X register 260, an input-Y register 261, decoders 262 and 263, an exponent-&-significand arithmetic circuit 264, selectors 265 and 266, a left shifter 267A, a right shifter 267B, an absolute-value adder 268, and an OVF&UDF-prediction circuit 269. The arithmetic device further includes an overlapping-digit discarding circuit 270, selectors 271 and 272, a normalization circuit 273, an encoder 274, and an output-Z register 275.

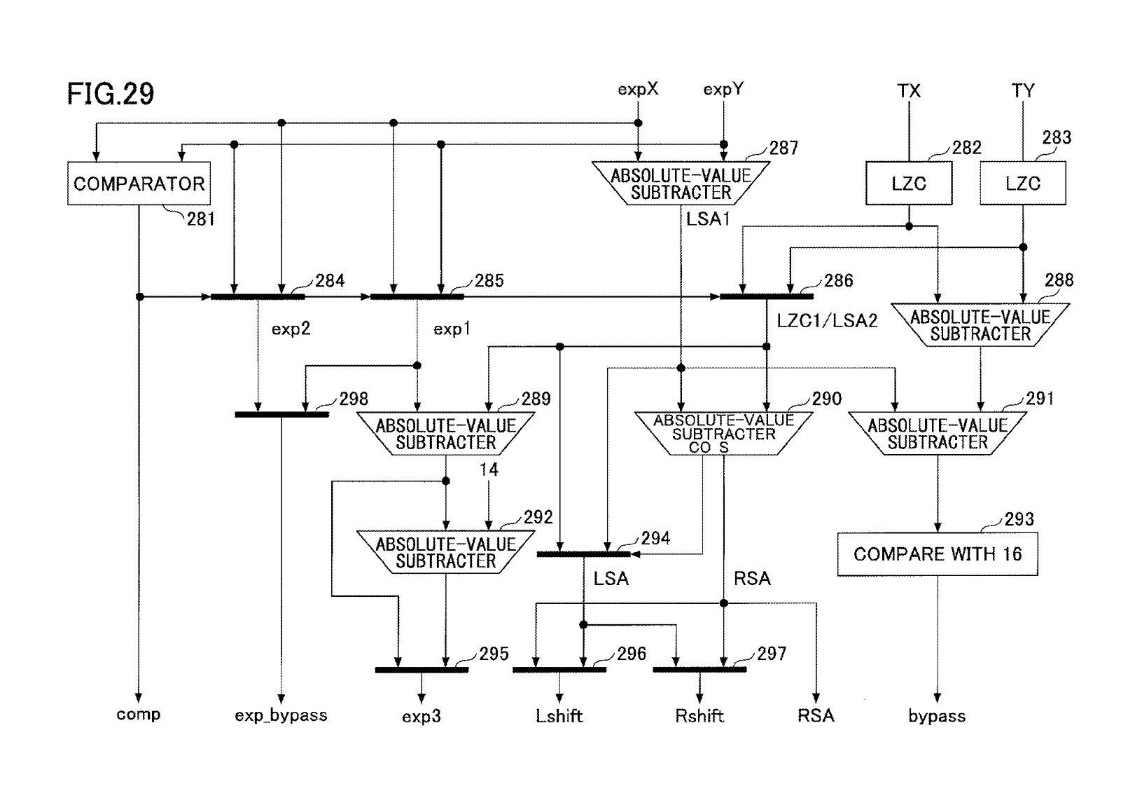

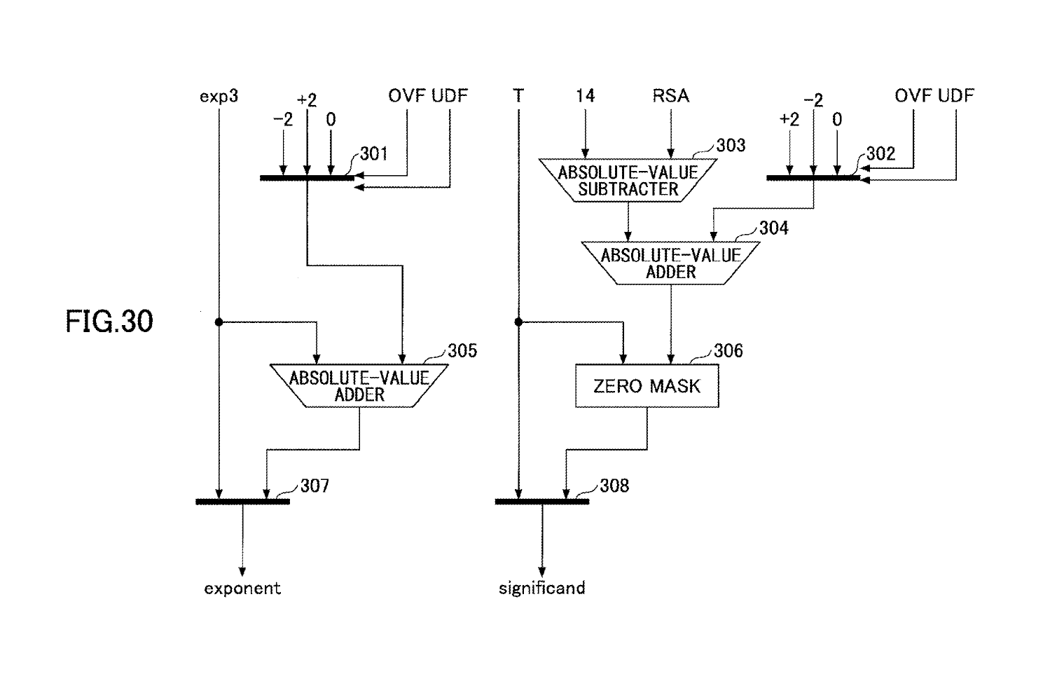

FIG. 29 is a drawing illustrating an example of the configuration of the exponent-&-significand arithmetic unit 264 of the arithmetic device illustrated in FIG. 28. The exponent-&-significand arithmetic unit 264 includes a comparator 281, LZC counters 282 and 283, selectors 284 through 286, absolute-value subtracters 287 through 292, a comparator 293, and selectors 294 through 298. FIG. 30 is a drawing illustrating an example of the configuration of the overlapping-digit discarding circuit 270 of the arithmetic device illustrated in FIG. 28. The normalization circuit 270 includes selectors 301 and 302, a subtracter 303, adders 304 and 305, a zero-mask circuit 306, and selectors 307 and 308. The arithmetic device illustrated in FIG. 28 differs from the arithmetic device illustrated in FIG. 23 in the configurations of the exponent-&-significand arithmetic circuit 264 of FIG. 29 and the overlapping-digit discarding circuit 270. Other corresponding circuit portions of the arithmetic device illustrated in FIG. 28 have the same configurations and operations as those of the arithmetic device illustrated in FIG. 23.

In the following, the operation of the arithmetic device illustrated in FIG. 28 through FIG. 30 will be described.

Data are supplied to the decoder 262 and the decoder 263 from the input-X register 260 and the input-Y register 261, respectively. Each of the decoders 262 and 263 divides an input into a sign, an exponent, and a significand, thereby converting the input into an internal format. The sign, exponent, and significand of the inputs X and Y are referred to as a sign-X, an exponent-X (expX), and a significand-X (TX), and a sign-Y, an exponent-Y (expY), and a significand-Y (TY), respectively.

The exponent-&-significand arithmetic unit 264 receives the exponent-X, the significand-X, the exponent-Y, and the significand-Y. The comparator 281 of the exponent-&-significand arithmetic unit 264 compares the exponent-X and the exponent-Y in terms of their magnitudes, and generates a select signal such that the significand associated with the larger exponent, which will be denoted as exp1, serves as a significand T1, and that the significand associated with the smaller exponent, which will be denoted as exp2, serves as a significand T2.

The absolute-value subtracter 291 and the comparator 293 of the exponent-&-significand arithmetic unit 264 perform an arithmetic for providing a bypass from an input to the normalization circuit 273 when the absolute value of {(exponent-X−the count indicative of the number of leading zeros in significand-X)−(exponent-Y−the count indicative of the number of leading zeros in significand-Y)} is larger than or equal to 16. The exponent-&-significand arithmetic unit 264 generates in the case of fixed-precision subtraction and addition a select signal such that the significand T1 and the sign and exponent associated therewith are bypassed, and generates in the case of the get_zz arithmetic a select signal such that the significand T2 and the sign and exponent associated therewith are bypassed. The exponent-&-significand arithmetic circuit 264 also outputs an exponent to be bypassed.

The absolute-value subtracter 287 of the exponent-&-significand arithmetic unit 264 sets a shift amount LSA1 equal to a value of (exp1−exp2). The selector 286 sets a shift amount LSA2 equal to the leading zero count of the significand T1 (i.e., the number of leading zeros in the significand T1). In the case of the count being an odd number, however, the count is decreased by one. The absolute-value subtracter 290 of the exponent-&-significand arithmetic unit 264 calculates (exponent exp1−exponent exp2−the count indicative of the number of leading zeros in significand T1), and outputs the calculated value as a shift amount RSA. When the leading zero count of the significand T1 is an odd number, this number is decreased by 1. The absolute-value subtracter 290 compares LSA1 and LSA2 as to their magnitude relationship. In response to the result of comparison, the selector 294 selects LSA2 as LSA in the case of LSA1 being smaller, and selects LSA2 as LSA in the case of LSA1 being larger.

The absolute-value subtracter 289 of the exponent-&-significand arithmetic unit 264 calculates an exponent exp3 that is the result of subtracting the leading zero count of the significand T1 from the exponent exp 1. In the case of the arithmetic being the get_zz arithmetic, the absolute-value subtracter 292 further subtracts 14 from the subtraction result, the result of which is used as the exponent exp3. The obtained exponent exp3 is output from the selector 295 to the overlapping-digit discarding circuit 270.

In the case of the arithmetic being a fixed-precision addition or subtraction, the exponent-&-significand arithmetic unit 264 supplies the shift amount RSA to the right shifter 267B and the shift amount LSA to the left shifter 267A. In the case of the arithmetic being a get_zz arithmetic, the exponent-&-significand arithmetic unit 264 supplies zero to the right shifter 267B and the shift amount RSA to the left shifter 267A.

The left shifter 267A shifts the supplied significand to the left according to the specified amount of shift. The right shifter 267B shifts the supplied significand to the right according to the specified amount of shift.

The significand T1 shifted to the left and the 14 lower-order digits (i.e., 56 bits) of the significand T2 shifted to the right are supplied to the absolute-value adder 268. In the case of subtraction, the significand of a subtrahend is inverted to generate one's complement, which is supplied as an input, with “1” being supplied as a carry bit to the absolute-value adder 268. The absolute-value adder 268 adds up the 14 lower-order digits (i.e., 56 bits) of inputs, and supplies the result to the overlapping-digit discarding circuit 270. Also, the carry-out bit is supplied from the absolute-value adder 268 to the OVF&UDF-prediction circuit 269.

The OVF&UDF-prediction circuit 269 receives the significand T1, the shift amount RSA, and the carry-out bit of the result of addition. The OVF&UDF-prediction circuit 269 predicts overflow. The OVF&UDF-prediction circuit 269 counts the number of consecutive 9s (1001₂) from the most significant digit of the significand T1. The OVF&UDF-prediction circuit 269 generates a flag indicative of the occurrence of overflow when the counted number of 9s is larger than the shift amount RSA, the carry-out bit is generated, and the arithmetic is an addition operation. The flag is supplied to the overlapping-digit discarding circuit 270.

Further, the OVF&UDF-prediction circuit 189 predicts underflow. The OVF&UDF-prediction circuit 189 counts the number of consecutive zeros from the most significant digit of the significand T1 while regarding “1” appearing the first time as “0”, thereby performing special leading zero counting. The OVF&UDF-prediction circuit 189 generates a flag indicative of the occurrence of underflow when this zero count is larger than the shift amount RSA, the carry-out bit is generated, and the arithmetic is a subtraction operation. The flag is supplied to the overlapping-digit discarding circuit 270.

The overlapping-digit discarding circuit 270 receives the addition result T from the absolute-value adder 268, the exponent exp3 and the shift amount RSA from the exponent-&-significand arithmetic unit 264, as well as the overflow flag OVF and the underflow flag UDF from the OVF&UDF-prediction circuit 269. The subtracter 303 of the overlapping-digit discarding circuit 270 calculates (14×(digit width of the significand)−shift amount RSA), and sets the mask amount equal to the calculated value. The adder 304 decreases the mask amount by two when the overflow flag is in the set state, and increases the mask amount by two when the underflow flag is in the set state. Further, the mask amount is set equal to zero upon detecting that the mask amount has become a negative number. In the case of the arithmetic being the get_zz arithmetic, the adder 305 of the overlapping-digit discarding circuit 270 increases the exponent exp3 by two when the overflow flag is in the set state, and decreases the exponent exp3 by two when the underflow flag is in the set state.

The zero-mask circuit 306 of the overlapping-digit discarding circuit 270 masks a certain number of digits of the upper-order digits of the significand where the certain number is equal to the mask amount.

In the case of the arithmetic being fi(x+y), the overlapping-digit discarding circuit 270 supplies the exponent exp3 and the addition result, without any changes thereto, to the normalization circuit 273. In the case of the arithmetic being get_zz, the overlapping-digit discarding circuit 270 supplies the exponent having experienced the addition or subtraction and the masked significand to the normalization circuit 273.

In the case of the bypass select signal to the normalization circuit 273 being 1, the bypassed significand and exponent are supplied to the normalization circuit 273. In the case of the bypass select signal to the normalization circuit 273 being 0, the significand and exponent output from the overlapping-digit discarding circuit 270 are supplied to the normalization circuit 273.

The normalization circuit 273 (which may have the same configuration as in FIG. 15) counts the number of leading zeros in the significand. When the leading zero count is an odd number, the correction unit decreases the leading zero count by one. The normalization circuit 273 subtracts the leading zero count of the significand from the exponent, and sets the result to the exponent-Z. The normalization circuit 273 shifts the significand to the left by the amount equal to the leading zero count of the significand, and sets the result to the exponent-Z.

The encoder 274 converts the sign, the exponent-Z, and the significand-Z into an external format for provision to the output-Z register 275.

According to at least one embodiment, a correction value for an added or subtracted value of floating point numbers is calculated by predicting overflow or underflow occurring in the result of adding upper-order digits, thereby calculating a correction value efficiently by use of a process that is independent of the upper-order-digit addition process.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present inventions have been described in detail, it should be understood that the various changes, substitutions, and alterations could be made hereto without departing from the spirit and scope of the invention.

What is claimed is:

1. An arithmetic circuit for calculating a correction value for a result of an arithmetic operation that is an addition or subtraction performed with respect to a first floating-point number and a second floating-point number smaller than the first floating-point number, comprising:
a first input register configured to store a first sign, a first significand, and a first exponent of the first floating-point number;
a second input register configured to store a second sign, a second significand, and a second exponent of the second floating-point number;
an arithmetic unit configured to produce a shift amount that is a result of subtracting from the first exponent the second exponent and also a leading zero count of the first significand, and to produce a third exponent that is a result of subtracting from the first exponent the leading zero count of the first significand and a first predetermined value;
a shift unit configured to generate a shifted significand that is a result of shifting the first significand based on the generated shift amount;
an addition unit configured to produce a sum obtained by adding the shifted significand to a portion of the second significand, and to produce carry information indicative of presence or absence of a carry generated together with the sum;
a prediction unit configured to generate a flag indicative of overflow or underflow based on the shifted significand, the shift amount, and the carry information; and
a generation unit configured to generate a significand of a normalized correction value for the result of the arithmetic operation and an exponent of the normalized correction value based on the second sign, the second significand, and the second exponent when a difference between a result of subtracting the leading zero count of the first significand from the first exponent and a result of subtracting a leading zero count of the second significand from the second exponent is larger than or equal to a second predetermined value, and to generate the significand and exponent of the normalized correction value based on the sum, the third exponent, the shift amount, and the flag when the difference is smaller than the second predetermined value.

2. The arithmetic circuit as claimed in claim 1, wherein the arithmetic unit is configured to generate the shift amount that is a result of subtracting from the first exponent the second exponent, the leading zero count of the first significand, and 1, when the leading zero count of the first significand is odd.

3. The arithmetic circuit as claimed in claim 1, wherein the prediction unit is configured to receive the shifted significand, the shift amount, and the carry information, to generate the flag indicative of the overflow when a number of consecutive digits each having an identical predetermined value from a most significant digit of the shifted significand is larger than or equal to the shift amount, the carry information is 1, and the arithmetic operation is an addition, and to generate the flag indicative of the underflow when a number of consecutive zeros from the most significant digit of the shifted significand is larger than or equal to the shift amount, the carry information is 1, and the arithmetic operation is a subtraction.

4. The arithmetic circuit as claimed in claim 3, wherein the prediction unit is configured to count the number of consecutive zeros from the most significant digit of the shifted significand by regarding “1” appearing a first time as “0”.

5. The arithmetic circuit as claimed in claim 1, wherein the generation unit is configured to generate a mask amount based on a digit width of the first significand, the shift amount, and the flag, to mask with one or more zeros the second significand or one or more upper-order digits of the sum based on the mask amount, to generate a third leading zero count that is a leading zero count of the masked significand obtained by masking the second significand or a leading zero count of the masked sum obtained by masking the sum, to generate the exponent of the normalized correction value that is a result of subtracting the third leading zero count from the third exponent, and to generate the significand of the normalized correction value that is a result of shifting the masked significand or the masked sum based on the leading zero count of the masked significand.

6. A processor, comprising:
an arithmetic circuit for calculating a correction value for a result of an arithmetic operation that is an addition or subtraction performed with respect to a first floating-point number and a second floating-point number smaller than the first floating-point number; and
an instruction control unit configured to decode an instruction for calculating the correction value,
wherein the arithmetic circuit includes:
a first input register configured to store a first sign, a first significand, and a first exponent of the first floating-point number;
a second input register configured to store a second sign, a second significand, and a second exponent of the second floating-point number;
an arithmetic unit configured to produce a shift amount that is a result of subtracting from the first exponent the second exponent and also a leading zero count of the first significand, and to produce a third exponent that is a result of subtracting from the first exponent the leading zero count of the first significand and a first predetermined value;
a shift unit configured to generate a shifted significand that is a result of shifting the first significand based on the generated shift amount;
an addition unit configured to produce a sum obtained by adding the shifted significand to a portion of the second significand, and to produce carry information indicative of presence or absence of a carry generated together with the sum;
a prediction unit configured to generate a flag indicative of overflow or underflow based on the shifted significand, the shift amount, and the carry information; and
a generation unit configured to generate a significand of a normalized correction value for the result of the arithmetic operation and an exponent of the normalized correction value based on the second sign, the second significand, and the second exponent when a difference between a result of subtracting the leading zero count of the first significand from the first exponent and a result of subtracting a leading zero count of the second significand from the second exponent is larger than or equal to a second predetermined value, and to generate the significand and exponent of the normalized correction value based on the sum, the third exponent, the shift amount, and the flag when the difference is smaller than the second predetermined value.

7. A method of controlling a processor which includes:
a first input register configured to store a first sign, a first significand, and a first exponent of the first floating-point number;
a second input register configured to store a second sign, a second significand, and a second exponent of the second floating-point number;
an arithmetic circuit configured to calculate a correction value for a result of an arithmetic operation that is an addition or subtraction performed with respect to the first floating-point number and the second floating-point number smaller than the first floating-point number; and
an instruction control unit configured to decode an instruction for calculating the correction value, the method comprising:
decoding the instruction by use of the instruction control unit;
producing, by use of an arithmetic unit of the arithmetic circuit, a shift amount that is a result of subtracting from the first exponent the second exponent and also a leading zero count of the first significand, and to produce a third exponent that is a result of subtracting from the first exponent the leading zero count of the first significand and a first predetermined value;
generating, by use of a shift unit of the arithmetic circuit, a shifted significand that is a result of shifting the first significand based on the generated shift amount;
producing, by use of an addition unit of the arithmetic circuit, a sum obtained by adding the shifted significand to a portion of the second significand, and to produce carry information indicative of presence or absence of a carry generated together with the sum;
generating, by use of a prediction unit of the arithmetic circuit, a flag indicative of overflow or underflow based on the shifted significand, the shift amount, and the carry information; and
generating, by use of a generation unit of the arithmetic circuit, a significand of a normalized correction value for the result of the arithmetic operation and an exponent of the normalized correction value based on the second sign, the second significand, and the second exponent when a difference between a result of subtracting the leading zero count of the first significand from the first exponent and a result of subtracting a leading zero count of the second significand from the second exponent is larger than or equal to a second predetermined value; and
generating, by use of the generation unit of the arithmetic circuit, the significand and exponent of the normalized correction value based on the sum, the third exponent, the shift amount, and the flag when the difference is smaller than the second predetermined value.
